(19) United States
(12) Patent Application Publication
(10) Pub. No.: US 2026/0159722 A1
(43) Pub. Date: Jun. 11, 2026

(54) HIGH TEMPERATURE CORROSION RESISTANT ORGANIC-INORGANIC HYBRID COATINGS

(71) Applicant: NDSU RESEARCH FOUNDATION, Fargo, ND (US)

(72) Inventors: Xiaoning QI, Fargo, ND (US); Joshua DOCKTER, Reile's Acres, ND (US)

(21) Appl. No.: 19/181,025

(22) Filed: Apr. 16, 2025

Related U.S. Application Data
(60) Provisional application No. 63/634,667, filed on Apr. 16, 2024.

(51) Int. Cl. C09D 183/04; C09D 5/08; C09D 5/18; C09D 7/61; C23C 30/00

(52) U.S. Cl. CPC C09D 183/04; C09D 5/08; C09D 5/18; C09D 7/61; C23C 30/005

(57) ABSTRACT

The disclosure relates to a method for preparing a corrosive-resistant product, comprising: coating a metal substrate with a pre-ceramic polymer composition comprising at least one silicone resin, at least one glass frit dispersed in the silicone resin, and optionally at least one solvent, wherein the metal substrate is at least partially coated; and subjecting the coated metal substrate to thermal treatment to diffuse metal oxides, metal hydroxides, and/or metal oxyhydroxides from the metal substrate into a coating matrix and induce crosslinking and pyrolysis of the at least one silicone resin to prepare a metal-oxide-impregnated polymer-derived ceramic. The disclosure relates to a coated substrate, comprising: a metal substrate; and a metal-oxide-impregnated polymer-derived ceramic coating comprising the metal oxide, metal hydroxides, and/or metal oxyhydroxide, and at least one glass frit. The disclosure relates to an article of manufacture.

### CROSS-REFERENCE TO RELATED APPLICATIONS

This application claims priority to U.S. Provisional Application No. 63/634,667, filed Apr. 16, 2024, the disclosures of which is incorporated herein by reference.

### BACKGROUND OF THE INVENTION

High-temperature coatings are critical in protecting surfaces exposed to harsh and extreme environments, such as those found in transportation exhaust systems, aerospace vehicles (particularly in advanced space launch operations), the energy sector, and various other industrial applications. Organic coatings, based on polymers with diverse chemical structures, have tailorable properties and can be applied using versatile methods. They are often preferred for a wide range of applications that require chemical resistance, mechanical strength, and thermal stability. However, organic polymers naturally possess only moderate heat resistance. This limitation led to the development of organic high-temperature polymers, including polyimides, polyetheretherketone polybenzimidazole, and various fluoropolymers such as polytetrafluoroethylene and perfluoroalkoxy polymers, etc. These polymers gain enhanced thermal stability from having structures with high decomposition energy: densely cross-linked chains, bonds with higher energy (e.g., carbon-hetero bonds), or a greater number of backbone bonds (e.g., ladder structures with double-stranded repeating units). However, polymers designed using these strategies often have poor processability that limits their applications as industrial coating materials. In contrast, ceramics are more heat-resistant than organic polymers due to their densely packed atomic structures and stronger bonding. Unlike organic coatings, ceramic coatings have limited uses, often because of their prohibitive application cost, which is associated with methods such as thermal spraying, chemical vapor deposition (CVD), and physical vapor deposition (PVD).

Polymer-derived ceramic (PDC) coatings combine the heat-resistance of ceramics and the application versatility of organic coatings, benefiting from their liquid precursors such as polysiloxanes, polysilazanes, polycarbosilanes, etc. The liquid form of the precursors eases PDC coatings' formulation and application. The final thermal conversion or pyrolysis of PDC coatings gives them the desirable thermal stability and corrosion resistance.

As an example of commonly used PDC precursors, polysiloxane typically undergoes an anaerobic pyrolysis process that transforms the polymer matrix into a glassy silicon oxycarbide (SiOC) ceramic. Alternatively, the precursor can be pyrolyzed aerobically if the ambient oxygen is not purged. The aerobic pyrolysis process may encourage the decomposition of SiOC into SiO₂ and carbon, particularly on the coating surfaces directly exposed to oxygen. Depending on the ambient oxygen content, a various amount of dispersed Si—O and Si—C bonds can form in the resultant three-dimensional covalent structure from the aerobic pyrolysis process. The covalent structure could contain five distinct units: SiO₄, SiO₃C, SiO₂C₂, SiOC₃, and SiC₄, along with free carbon atoms that reside within these units. Hence, this chemical structure is often described in a formula form as SiCₓO₂₍₁₋ₓ₎+yC_{free}, where SiCₓO₂₍₁₋ₓ₎ represents the amorphous silicon oxycarbide network, and C_{free} the free carbon. Among various PDC coatings, SiOC coatings have emerged as a particularly promising solution for high-temperature corrosion protection due to their unique combination of thermal stability, mechanical strength, and chemical resistance. Unlike traditional coatings, SiOC coatings exhibit exceptional resistance to oxidation, corrosion, and thermal degradation at elevated temperatures, making them ideal for use in harsh environments such as those encountered in industrial processes, aerospace, and energy sectors. The inherent flexibility in tuning the composition and structure of SiOC coatings further enhances their suitability for a wide range of high-temperature applications. Despite the growing interest in SiOC coatings and their desirable thermal stability from precursor-SiOC conversion, challenges remain in optimizing their performance, particularly in terms of long-term stability and protective efficiency under extreme conditions, as the required pyrolysis causes film shrinkage as large as 50% in volume. This significant shrinkage results from mass loss due to gaseous oxide evolution, which negatively affects PDC coatings' corrosion and mechanical performance. The selection of polymer precursors could reduce the shrinkage to a certain extent but is not able to completely eliminate it. In addition, due to the coefficient of thermal expansion (CTE) difference between PDCs and metals, PDC crack initiation and propagation intensify on a metallic substrate. At its worst, a SiOC coating film can fragment and lose adhesion to its substrate, resulting in severe material failure.

SiOC film defects caused by pyrolysis shrinkage can be reduced by adding passive fillers (e.g. BN, SiC, Al₂O₃, and ZrO₂) or active fillers (e.g. Al, Nb, TiSi₂, and ZrSi₂, etc.) to the polymer precursor. Passive fillers alleviate the shrinkage by occupying the free space in and between the shrinking PDC regions during pyrolysis. In contrast, active fillers compensate for the shrinkage through their volume expansion, which is a result of reactions with ambient gases and precursor conversion products released during the pyrolysis process. Lenz Leite et al., “G. Synthesis and Characterization of Yttrium and Ytterbium Silicates from Their Oxides and an Oligosilazane by the PDC Route for Coating Applications to Protect Si3N4 in Hot Gas Environments,” J. Eur. Ceram. Soc. 2017, 37 (16), 5177-5191 used Y₂O₃ and Yb₂O₃ fillers in polysilazanes to develop silicate coatings for hot gas oxidation protection of Si₃N₄. In another recent study, Tian et al., “Passive Filler-Loaded Silicon Oxycarbide Coating on Nickle Alloy with High Thermal Shocking Behavior and Oxidation Resistance,” Materials 2022, 15 (18), 6395 added Al₂O₃/YSZ (Yttria-stabilized Zirconia) passive filler to the SiOC to improve the thermal shocking and oxidation resistance in coatings. Despite reducing macroscopic shrinkage, adding fillers increases the porosity of PDC coatings, and cracks could still develop due to localized stresses, particularly around filler particles, especially in dense or thicker PDC coatings. Making thick PDC coatings without cracks on metallic substrates remains challenging and an obstacle to the broader application of PDC coatings. Passive glass frit (GF) fillers not only alleviate PDC shrinkage but also improve wetting and adhesion of PDC coatings on metallic substrates. Around its melting point temperature, a GF filler can improve surface wetting and form an adhesive interface. This is largely owing to the miscibility between glass, which is a mixture of oxides, and the existing oxide layer on a metal surface. Schutz et al., “Characterisation of Novel Precursor-Derived Ceramic Coatings with Glass Filler Particles on Steel Substrates,” Surf. Coat. Technol. 2012, 207, 319-327 developed a high-temperature abrasion-resistant coating using GF-filled polysilazanes. Recently, Nguyen et al., “Novel Polymer-Derived Ceramic Environmental Barrier Coating System for Carbon Steel in Oxidizing Environments,” J. Eur. Ceram. Soc. 2017, 37 (5), 2001-2010 used both active and passive fillers, and GF in a polysiloxane resin to make a crack-free environmental barrier coating.

Corrosion of a steel substrate is often mitigated by its passivation, which is the formation of a compact iron oxide film on the steel surface, acting as a barrier that slows the diffusion of ions and oxygen. The growth rate of this oxide film is proportional to the ambient temperature. High temperature accelerates the film growth due to increased iron and oxygen diffusion rate and higher potential energy of reactants. Depending on its surface composition and ambient temperature, steel oxidation can follow different oxidation kinetics, which subsequently determine whether the oxide film has a compact structure or is composed of loose layers. An existing oxide film prior to heat treatment can reduce a steel substrate's oxidation rate. As a result, the oxide film grows under the parabolic rate law, which are preferable because of the consequent three-layer protective structure: an outer hematite layer (Fe₂O₃), an intermediate magnetite layer (Fe₃O₄), and a thick inner wustite layer (FeO). This three-layer structure decreases both the outward (iron ions) and inward (oxygen ions) diffusion rate, thereby reducing the oxidation rate of the steel substrate and facilitating the formation of a protective barrier oxide film.

High-temperature organic coatings protect assets well at moderately elevated temperatures. However, they degrade severely at higher temperatures (e.g., above 450° C.), leaving little or no corrosion protection to the substrate. Therefore, a new approach to making a SiOC coating film corrosion-resistant at high temperatures is needed

### SUMMARY OF THE DISCLOSURE

The disclosure relates to a method for preparing a corrosive-resistant product, comprising, consisting of, or consisting essentially of: coating a metal substrate with a pre-ceramic polymer composition comprising, consisting of, or consisting essentially of at least one silicone resin, at least one glass frit dispersed in the silicone resin, and optionally at least one solvent, wherein the metal substrate is at least partially coated; and subjecting the coated metal substrate to thermal treatment to diffuse metal oxides, metal hydroxides, and/or metal oxyhydroxides from the metal substrate into a coating matrix and induce crosslinking and pyrolysis of the at least one silicone resin to prepare a metal-oxide-impregnated polymer-derived ceramic.

The disclosure also relates to a method for preparing a corrosive-resistant product, comprising: coating a substrate with a pre-ceramic polymer composition comprising, consisting of, or consisting essentially of at least one silicone resin, at least one glass frit dispersed in the silicone resin, and optionally at least one solvent, wherein the substrate is at least partially coated; optionally, adding at least one metal; and subjecting the coated substrate to thermal treatment to diffuse metal oxides into a coating matrix and induce crosslinking and pyrolysis of the at least one silicone resin to prepare a metal-oxide-impregnated polymer-derived ceramic.

The disclosure also relates to a coated substrate, comprising: a metal substrate; and a metal-oxide-impregnated polymer-derived ceramic coating comprising at least one metal oxide, metal hydroxide, and/or metal oxyhydroxide, and at least one glass frit.

The disclosure also relates to a coated substrate, comprising, consisting of, or consisting essentially of: a substrate; and a metal-oxide-impregnated polymer-derived ceramic coating comprising at least one metal oxide, metal hydroxide, and/or metal oxyhydroxide, and at least one glass frit.

The disclosure also relates to a coating film, comprising, consisting of, or consisting essentially of: a metal-oxide-impregnated polymer-derived ceramic coating comprising at least one metal oxides, metal hydroxides, and/or metal oxyhydroxides, and at least one glass frit.

The disclosure also relates to an article of manufacture comprising an object, wherein at least a portion of at least one surface of the object is the coated substrate of the disclosure, which comprises a metal substrate comprising at least one metal, and at least one metal oxides, metal hydroxides, and/or metal oxyhydroxides; and a metal-oxide-impregnated polymer-derived ceramic coating comprising the metal oxide and/or metal oxyhydroxide from the metal substrate, and at least one glass frit.

The invention also relates to an article of manufacture comprising an object, where at least a portion of at least one surface of the object comprises the coating film of the disclosure. The coating film, comprising, consisting of, or consisting essentially of: at least one metal comprising at least one metal oxide, metal hydroxides, and/or metal oxyhydroxide; and a metal-oxide-impregnated polymer-derived ceramic coating comprising the metal oxides, metal hydroxides, and/or metal oxyhydroxides from the metal substrate, and at least one glass frit.

The invention also relates to an article of manufacture comprising the coating film of the disclosure.

### BRIEF DESCRIPTION OF THE FIGURES

FIG. 1 shows a schematic of the polymer-derived ceramic (PDC) silicon oxycarbide (SiOC) coating sample preparation process, wherein the coating samples were prepared through the following steps: 1) surface preparation by medium-blasting, cleaning, and drying, 2) preparation the glass frit filler and coating formulation, 3) homogenization of the formulation via high-speed dispersion, 4) liquid film application using a drawdown applicator, and 5) one-hour heat treatment(s) under ambient conditions.

FIG. 2 shows photos of HC00 coatings after being treated at different temperatures and 168 hours of neutral salt spray (NSS) following ASTM B117.

FIG. 3 shows photos of HC35 coatings after being treated at different temperatures and 168 hours of neutral salt spray (NSS) following ASTM B117.

FIG. 4 shows photos of HC45 coatings after being treated at different temperatures and 168 hours of neutral salt spray (NSS) following ASTM B117.

FIG. 5 shows photos of HC55 coatings after being treated at different temperatures and 168 hours of neutral salt spray (NSS) following ASTM B117.

FIG. 6A shows low-frequency (0.01 Hz) impedance moduli of coatings before NSS exposure following ASTM B117.

FIG. 6B shows low-frequency (0.01 Hz) impedance moduli of coatings after NSS exposure following ASTM B117.

FIG. 7 shows nanoindentation load-displacement curves.

FIG. 8 shows thermogravimetric analysis (TGA) of the control coating (HC00-RT) and coatings with 35% glass frits (HC-35): a) HC00-RT, b) HC35-RT, c) HC35-800, d) HC35-1000, and e) HC35-1400.

FIG. 9 shows FTIR spectra of coatings HC00, HC35, HC45, and HC55 treated at 427° C.

FIG. 10 shows FTIR spectra of coatings HC00, HC35, HC45, and HC55 treated at 538° C.

FIG. 11 shows FTIR spectra of coatings HC00, HC35, HC45, and HC55 treated at 760° C.

FIG. 12 shows Raman spectra of samples HC00, HC35, HC45, and HC55 after being treated at 427° C.

FIG. 13 shows Raman spectra of samples HC00, HC35, HC45, and HC55 after being treated at 538° C.

FIG. 14 shows Raman spectra of coatings HC00, HC35, HC45, and HC55 treated at 760° C.

FIG. 15 shows optical microscope images of coating samples treated at different temperatures.

FIG. 16A shows XRD patterns of coating samples HC00, HC35, HC45, and HC55 thermally treated at 427° C.

FIG. 16B shows XRD patterns of coating samples HC00, HC35, HC45, and HC55 thermally treated at 538° C.

FIG. 16C shows XRD patterns of coating samples HC00, HC35, HC45, and HC55 thermally treated at 760° C.

FIG. 17A shows XPS spectra of sample HC35 at different thermal treatment temperatures (top spectra corresponds to 427° C., middle spectra corresponds to 538° C., and bottom spectra corresponds to 760° C.), wherein the spectra correspond to survey spectra.

FIG. 17B shows XPS spectra of sample HC35 at different thermal treatment temperatures (top spectra corresponds to 427° C., middle spectra corresponds to 538° C., and bottom spectra corresponds to 760° C.), wherein the spectra correspond to C 1s deconvoluted spectra.

FIG. 17C shows spectra of sample HC35 at different thermal treatment temperatures (top spectra corresponds to 427° C., middle spectra corresponds to 538° C., and bottom spectra corresponds to 760° C.), wherein the spectra correspond to O 1s deconvoluted spectra.

FIG. 17D shows spectra of sample HC35 at different thermal treatment temperatures (top spectra corresponds to 427° C., middle spectra corresponds to 538° C., and bottom spectra corresponds to 760° C.), wherein the spectra correspond to Si 2p deconvoluted spectra.

FIG. 17E shows spectra of sample HC35 at different thermal treatment temperatures (top spectra corresponds to 427° C., middle spectra corresponds to 538° C., and bottom spectra corresponds to 760° C.), wherein the spectra correspond to Fe 2p deconvoluted spectra.

FIG. 18 shows oxidation kinetics of HC35 at elevated temperatures.

FIG. 19 shows magnetic property of samples being treated at higher temperatures. Samples from left to right correspond to the following samples: HC35-800, HC35-1400, HC45-800, HC45-1400, HC55-800, and HC55-1400.

FIG. 20A shows a cross-section image from a digital optical microscope corresponding to HC00-RT.

FIG. 20B shows a cross-section image from a digital optical microscope corresponding to HC35-1400.

FIG. 20C shows a cross-section image from a digital optical microscope corresponding to HC55-1400.

FIG. 21A shows sample HC00-RT surface roughness characterized by an optical profilometer in 2D.

FIG. 21B shows sample HC00-RT surface roughness characterized by an optical profilometer in 3D.

FIG. 21C shows sample HC55-RT surface roughness characterized by an optical profilometer in 2D.

FIG. 21D shows sample HC55-RT surface roughness characterized by an optical profilometer in 3D.

FIG. 21E shows sample HC55-800 surface roughness characterized by an optical profilometer in 2D.

FIG. 21F shows sample HC55-800 surface roughness characterized by an optical profilometer in 3D.

FIG. 21G shows sample HC55-1000 surface roughness characterized by an optical profilometer in 2D.

FIG. 21H shows sample HC55-1000 surface roughness characterized by an optical profilometer in 3D.

FIG. 21I shows sample HC55-1400 surface roughness characterized by an optical profilometer in 2D.

FIG. 21J shows sample HC55-RT surface roughness characterized by an optical profilometer in 3D.

FIG. 22A shows coating cross-section morphology from SEM backscattering images corresponding to samples HC00-RT.

FIG. 22B shows coating cross-section morphology from SEM backscattering images corresponding to samples HC35-1400.

FIG. 23 shows cross-section elemental mapping of a thermally treated coating sample with glass frits.

FIG. 24 shows a schematic of the crack-free hybrid coating formation mechanism.

### DETAILED DESCRIPTION OF THE DISCLOSURE

Unless otherwise indicated, the definitions and embodiments described in this and other sections are intended to be applicable to all embodiments and aspects of the present disclosure herein described for which they are suitable as would be understood by a person skilled in the art.

The term “and/or,” as used herein, means either or both (or any combination or all of the terms or expressed referred to), e.g., “A, B, and/or C” encompasses A alone, B alone, C alone, A and B, A and C, B and C, and A, B, and C.

As used in the present disclosure, the singular forms “a,” “an,” and “the” include plural references unless the content clearly dictates otherwise. For example, an embodiment including “a compound” should be understood to present certain aspects with one compound, or two or more additional compounds. It will be understood by those with skill in the art that if a specific number of an introduced claim element is intended, such intent will be explicitly recited in the claim, and in the absence of such recitation no such limitation is present. For a non-limiting example, as an aid to understanding, the appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrase “one or more” or “at least one” and indefinite articles, such as “a” or “an”; the same holds true for the use in the claims of definite articles.

As used in this disclosure and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives, as used herein, are intended to be closed terms that specify the presence of the stated features, elements, components, groups, integers and/or steps and also exclude the presence of other unstated features, elements, components, groups, integers, and/or steps.

The term “consisting essentially of,” as used herein, is intended to specify the presence of the stated features, elements, components, groups, integers, and/or steps as well as those that do not materially affect the basic and novel characteristic(s) of those features, elements, components, groups, integers, and/or steps.

The term “metal oxide,” as used herein, refers to metal oxides, metal hydroxides, and/or metal oxyhydroxides.

The term “rust,” as used herein, refers to iron oxide, iron hydroxides, and/or iron oxyhydroxide.

### SiOC Coating Film

When a steel substrate with a glass frit-filed polymer derived ceramic (PDC) coating is subjected to a thermal treatment, a synergy of three processes is supported by characterization results: 1) the PDC conversion, 2) the glass frit filler plasticizing the SiOC film, and 3) the growth of oxide film.

The present disclosure relates to a new approach to making a coating film (e.g., SiOC coating film) that starts with an ambient-cured glass frit-filled silicone film (e.g., polysiloxane film), followed by its conversion to a glassy ceramic film (e.g., SiOC glassy ceramic film) by an open-to-air on-substrate thermal treatment. It has been discovered that, during the thermal treatment process, high-temperature oxidation/corrosion products (e.g., iron oxidation/corrosion products such as iron oxides and iron oxyhydroxides) intermix with glass phases in the film (melting glass frit fillers and converted PDCs) and form a final coherent and adherent thin film. Characterization of the hybrid coating, especially its chemical composition evolution, revealed that the organic-inorganic conversion goes through three stages. Together with the plasticizing glass fillers, the PDC conversion (e.g., SiOC conversion) and substrate oxidation process resulted in a defect-free corrosion-resistant PDC barrier film (e.g., SiOC barrier film). The films formed have no cracks and exhibit competitive anti-corrosion performance even after being treated at temperatures up to 760° C. Results show that the iron oxides and oxyhydroxides are critical components of the final film, eliminating film shrinkage similar to an active filler. In the Examples below, coating samples were loaded with different amounts of glass frit fillers (0%, 35%, 45%, and 55% by weight) and treated at different temperatures (room temperature, 427° C., 538° C., and 760° C.). Film properties, the chemical composition of the film at different thermal treatment stages, and the role of iron oxides are characterized below

The disclosure relates to coating a metal substrate with a pre-ceramic polymer composition. Then during heating, the following processes happen simultaneously: a metal surface of the metal substrate (at pre-ceramic polymer composition/metal interface) oxidizes; the pre-ceramic polymer composition converts to a polymer-derived ceramic; the oxygen continues diffusing into the pre-ceramic polymer composition/polymer-derived ceramic (during polymer-derived ceramic conversion); at least one metal ion continues diffusing into the pre-ceramic polymer composition/polymer-derived ceramic (during polymer-derived ceramic conversion); at least one metal oxide continues growing until the ceramic film is well formed; and then the oxygen slowly stops diffusing into the polymer-derived ceramic and the at least one metal ion slowly stops diffusing into polymer-derived ceramic because the ceramic film is fully converted from the pre-ceramic polymer composition to the polymer-derived ceramic.

### Methods for Preparing a Corrosive-Resistant Product

The disclosure relates to a method for preparing a corrosive-resistant product, comprising: coating a metal substrate with a pre-ceramic polymer composition comprising, consisting of, or consisting essentially of at least one silicone resin, at least one glass frit dispersed in the silicone resin, and optionally at least one solvent, wherein the metal substrate is at least partially coated; and subjecting the coated metal substrate to thermal treatment to diffuse metal oxides from the metal substrate into a coating matrix and induce crosslinking and pyrolysis of the at least one silicone resin to prepare a metal-oxide-impregnated polymer-derived ceramic.

### The Disclosure Relates to a Method for Preparing a Corrosive-Resistant Product, Comprising:

coating a metal substrate with a pre-ceramic polymer composition comprising, consisting of, or consisting essentially of at least one silicone resin, at least one glass frit dispersed in the silicone resin, and optionally at least one solvent, wherein the metal substrate is at least partially coated;
optionally, mixing the pre-ceramic polymer composition with at least one metal powder; and
subjecting the coated metal substrate to thermal treatment to diffuse metal oxides from the metal substrate into a coating matrix and induce crosslinking and pyrolysis of the at least one silicone resin to prepare a metal-oxide-impregnated polymer-derived ceramic.

### The Disclosure Also Relates to a Method for Preparing a Corrosive-Resistant Product, Comprising:

coating a substrate with a pre-ceramic polymer composition comprising, consisting of, or consisting essentially of at least one silicone resin, at least one glass frit dispersed in the silicone resin, and optionally at least one solvent, wherein the substrate is at least partially coated;
optionally, adding at least one metal; and
subjecting the coated substrate to thermal treatment to diffuse metal oxides into a coating matrix and induce crosslinking and pyrolysis of the at least one silicone resin to prepare a metal-oxide-impregnated polymer-derived ceramic.

A substrate may be a base material upon which a pre-ceramic polymer composition of this disclosure is applied. The substrate may be a metal substrate. The substrate may be an inert substrate. The inert substrate may be a ceramic substrate that is able to withstand high temperatures (e.g., magnesium oxide, zirconia, platinum, or silicone carbide). The metal oxide-impregnated polymer-derived ceramic may be a free-standing film. The at least one metal may comprise, consist of, or consist essentially of metal oxides, metal hydroxides, and/or metal oxyhydroxides. The metal oxides, metal hydroxides, and/or metal oxyhydroxides may grow by the reaction of the at least one metal with ambient oxygen diffused into the interface of the pre-ceramic polymer composition and metal-oxide-impregnated polymer-derived ceramic through the coating process. The oxygen may continue diffusing into the pre-ceramic polymer composition/metal-oxide-impregnated polymer-derived ceramic (during polymer-derived ceramic conversion). At least one metal ion may continue diffusing into the pre-ceramic polymer composition/metal-oxide-impregnated polymer-derived ceramic (during polymer-derived ceramic conversion). The at least one metal oxide may continue growing until the ceramic film is well formed. Then the oxygen may slowly stop diffusing into the metal-oxide-impregnated polymer-derived ceramic and the at least one metal ion may slowly stop diffusing into metal-oxide-impregnated polymer-derived ceramic as the ceramic film is fully converted from the pre-ceramic polymer composition to the polymer-derived ceramic. The at least one metal oxide may be iron oxides, aluminum oxides, copper oxides, titanium oxides, magnesium oxides, nickel oxides, or combinations thereof. The method for preparing the corrosive-resistant product may further comprise adding a metal powder into the pre-ceramic polymer composition. The at least one metal may be a metal powder. The metal powder may comprise, consist of, or consist essentially of metal oxides, metal hydroxides, metal oxyhydroxides, or combinations thereof. The at least one metal powder may be an iron powder, an aluminum powder, a copper powder, a titanium powder, a magnesium powder, a nickel powder, or combinations thereof. The method for preparing the corrosive-resistant product may further comprise adding a metal oxide powder into the pre-ceramic polymer composition; wherein the metal oxide powder may be an iron oxide powder, an aluminum oxide powder, a copper oxide powder, a titanium oxide powder, a magnesium oxide powder, a nickel oxide powder, or combinations thereof. The pre-ceramic polymer composition may further comprise a metal oxide powder; wherein the metal oxide powder is an iron oxide powder, an aluminum oxide powder, a copper oxide powder, a titanium oxide powder, a magnesium oxide powder, a nickel oxide powder, or combinations thereof. The method for preparing the corrosive-resistant product, wherein the substrate is a metal substrate or wherein the substrate is an inert substrate, further comprising adding the metal powder into the pre-ceramic polymer composition. Thermal treatment may cause the metal oxides, metal hydroxides, and/or metal oxyhydroxides to diffuse into a coating matrix. The thermal treatment may cause the metal oxides and/or metal oxyhydroxides to partially diffuse into the coating matrix. The thermal treatment may cause the metal oxides and/or metal oxyhydroxides to fully diffuse into the whole coating matrix.

The metal substrate may comprise, consist of, or consist essentially of iron or alloys thereof (e.g., steel, or stainless steel), aluminum or alloys thereof, copper or alloys thereof, titanium or alloys thereof, magnesium or alloys thereof, nickel or alloys thereof, and combinations thereof. The metal substrate may contain metal oxides. The metal oxides may comprise, consist of, or consist essentially of metal oxides, metal hydroxides, and/or metal oxyhydroxides. The metal oxides, metal hydroxides, and/or metal oxyhydroxides may grow by the reaction of the metal substrate with ambient oxygen diffused into the interface of the pre-ceramic polymer composition and metal-oxide-impregnated polymer-derived ceramic through the coating process. The oxygen may continue diffusing into the pre-ceramic polymer composition/metal-oxide-impregnated polymer-derived ceramic (during polymer-derived ceramic conversion). At least one metal ion may continue diffusing into the pre-ceramic polymer composition/metal-oxide-impregnated polymer-derived ceramic (during polymer-derived ceramic conversion). The at least one metal oxide may continue growing until the ceramic film is well formed. Then the oxygen may slowly stop diffusing into the metal-oxide-impregnated polymer-derived ceramic and the at least one metal ion may slowly stop diffusing into metal-oxide-impregnated polymer-derived ceramic as the ceramic film is fully converted from the pre-ceramic polymer composition to the polymer-derived ceramic. The metal oxides may be iron oxides, aluminum oxides, copper oxides, titanium oxides, magnesium oxides, nickel oxides, or combinations thereof. The metal oxides may be iron oxides, iron hydroxides, and/or iron oxyhydroxides. The metal oxides may form a metal oxide film on the metal substrate. Thermal treatment may cause the metal oxides, metal hydroxides, and/or metal oxyhydroxides of the metal substrate to diffuse into a coating matrix. The thermal treatment may cause the metal oxides, metal hydroxides, and/or metal oxyhydroxides of the metal substrate to partially diffuse into the coating matrix. The thermal treatment may cause the metal oxides, metal hydroxides, and/or metal oxyhydroxides of the metal substrate to fully diffuse into the whole coating matrix.

The thermal treatment accelerates the growth of the metal oxide layer. If the metal oxide layer grows too slow, there would not be sufficient oxide in the metal-oxide-impregnated polymer-derived ceramic to compensate for film shrinkage, which causes cracking. The diffused metal oxides, metal hydroxides, and/or metal oxyhydroxides in the coating matrix may cause the ceramic film to be crack-free. The coating matrix may be a matrix comprising, consisting of, or consisting essentially of the pre-ceramic polymer composition of the disclosure. The thermal treatment may induce crosslinking and pyrolysis of the at least one silicone resin to prepare the metal-oxide-impregnated polymer-derived ceramic.

The metal substrate may be free of rust, corrosion, or a metal oxide film prior to thermal treatment. The metal substrate may comprise, consist of, or consist essentially of iron and/or steel; wherein the iron and/or steel substrate may contain rust; wherein the rust may comprise, consists of, or consists essentially of metal oxides; wherein the metal oxides of the rust are iron oxides; wherein the iron oxides may be iron oxides, iron hydroxides, and/or iron oxyhydroxides; wherein the thermal treatment may cause a film of rust (e.g., metal oxide film) to form at the interface between the metal-oxide-impregnated polymer-derived ceramic and metal substrate; wherein the thermal treatment may accelerate the growth of rust at the interface between the metal substrate and the pre-ceramic polymer composition as it is converted into the metal-oxide-impregnated polymer-derived ceramic; and wherein thermal treatment may cause the iron oxides, iron hydroxides, and/or iron oxyhydroxides from the rust film (e.g., metal oxide film) to diffuse into the coating matrix. The rust may be present on the metal substrate prior to coating the metal substrate with the pre-ceramic polymer composition and subjecting the coated metal substrate to thermal treatment. At least a portion of the metal substrate may contain the metal oxide film (e.g., rust film) at the interface between the metal-oxide-impregnated polymer-derived ceramic and metal substrate. The thermal treatment may cause the growth of the metal oxide film at the interface between the metal-oxide-impregnated polymer-derived ceramic and metal substrate and the PDC conversion (e.g., SiOC conversion) to be synchronized. The metal oxide film growth may be synchronized with the crosslinking and pyrolysis of the at least one silicone resin (e.g., SiOC conversion) to prepare a metal-oxide-impregnated polymer-derived ceramic. The metal oxide film may grow on the metal substrate from non-existence.

The metal-oxide-impregnated into the polymer-derived ceramic may comprise, consist of, or consist essentially of FeO, Fe₂O₃, Fe₃O₄, Fe(OH)₂, Fe(OH)₃, FeOOH, or a combination comprising two or more thereof. The metal-oxide-impregnated into the polymer-derived ceramic may comprise, consist of, or consist essentially of FeO, Fe₂O₃, Fe₃O₄, FeOOH, or a combination comprising two or more thereof. The metal oxide layer may comprise, consist of, or consist essentially of distinct layers on top of iron; wherein the distinct layers may be FeO, Fe₃O₄, and Fe₂O₃. The metal oxide layer may be mixed with the pre-polymer ceramic composition. The metal oxide layer may be distinct under the metal-oxide impregnated polymer-derived ceramic. The substrate may be at least partially coated with the pre-polymer composition. The substrate may be fully coated with the pre-ceramic polymer composition.

The disclosure also relates to the pre-ceramic polymer composition which may comprise, consist of, or consist essentially of at least one silicone resin, at least one glass frit, and optionally at least one solvent. The at least one glass frit may be dispersed in the at least one silicone resin. The pre-ceramic polymer composition may be liquid. The pre-ceramic polymer composition may further comprise the at least one metal powder.

The at least one silicone resin may comprise, consist of, or consist essentially of a polysiloxane resin, a polycarbosiloxane resin, a polycarbosilane resin, a polycarbodiimide resin, a polysilazane resin, a polyborosilazane resin, a polyborosilane resin, a polyborosiloxane resin, polysilsesquioxanes, or a combination comprising two or more thereof; wherein the at least one silicone resin may comprise, consists of, or consists essentially of a polysiloxane resin; and wherein the at least one silicone resin may comprise, consists of, or consists essentially of poly(methylphenylsiloxane). The at least one silicone resin may have a viscosity of 10 mPas to 15,000 mPas at 25° C. (e.g., 10 mPas to 15,000 mPas at 25° C., 10 mPas to 7,000 mPas at 25° C., 10 mPas to 5,000 mPas at 25° C., 10 mPas to 500 mPas at 25° C., 10 mPas to 200 mPas at 25° C., 50 mPas to 15,000 mPas at 25° C., 50 mPas to 7,000 mPas at 25° C., 50 mPas to 5,000 mPas at 25° C., 50 mPas to 500 mPas at 25° C., 50 mPas to 200 mPas at 25° C., 500 mPas to 15,000 mPas at 25° C., 500 mPas to 7,000 mPas at 25° C., 500 mPas to 5,000 mPas at 25° C., or 7,000 mPas to 15,000 mPas at 25° C.). The at least one silicone resin may have a viscosity of 10 mPas to 200 mPas at 25° C. The at least one silicone resin may have a viscosity of 50 mPas to 500 mPas at 25° C. The at least one silicone resin may have a viscosity of 500 mPas to 5,000 mPas at 25° C. The at least one silicone resin may have a viscosity of 7,000 mPas to 15,000 mPas at 25° C. The at least one silicone resin may have a viscosity of 10 mPas to 5,000 mPas at 25° C. The at least one silicone resin may have a viscosity of 3,000 mPas at 25° C. The at least one silicone resin may be Silikophen P 80/X.

The at least one silicone resin may comprise, consist of, or consist essentially of at least one silane based sol-gel. The at lease one silane based sol-gel may be alkoxysilane-based sol-gel; wherein the alkoxysilane-based sol-gel is selected from the group consisting of tetraethoxysilane, tetramethoxysilane, and combinations thereof.

Based on the total weight of the pre-ceramic polymer composition, the at least one silicone resin may be present in an amount of 30 percent by weight (wt. %) to 95 percent by weight (wt. %) (e.g., 40 wt. % to 85 wt. %, 40 wt. % to 70 wt. %, 40 wt. % to 62 wt. %, or 40 wt. % to 52 wt. %).

The at least one glass frit may have a melting point below 450° C. (e.g., below 427° C., below 400° C., below 350° C., below 300° C., below 250° C.). The at least one glass frit may have a melting point in the range of 200° C. to 450° C. (e.g., 200° C. to 427° C., 200° C. to 400° C., 200° C. to 350° C., 200° C. to 300° C., 200° C. to 250° C., 250° C. to 427° C., 250° C. to 400° C., 250° C. to 350° C., 250° C. to 300° C., 300° C. to 427° C., 300° C. to 400° C., 300° C. to 350° C., 350° C. to 427° C., 350° C. to 400° C., or 400° C. to 450° C.). The at least one glass frit may have a melting point in the range of 200° C. to 800° C. (e.g., 250° C. to 700° C., 300° C. to 600° C., or 350° C. to 500° C.). The at least one glass frit may comprise, consists of, or consists essentially of Li₂O, B₂O₃, Na₂O, Al₂O₃, SiO₂, K₂O, CaO, ZnO, Bi₂O₃, V₂O₅, F, TiO₂, or a combination comprising two or more thereof. The glass frit mixture may have a weight percentage of each glass frit present in the mixture, based on the total weight of the glass frit mixture, of 1 wt. % to 10 wt. % Li₂O (e.g., 1 wt. % to 9 wt. %, 2 wt. % to 8 wt. %, 3 wt. % to 7 wt. %, or 4 wt. % to 6 wt. %), 1 wt. % to 50 wt. % B₂O₃ (e.g., 5 wt. to 45 wt. %, 10 wt. % to 40 wt. %, 15 wt. % to 35 wt. %, or 20 wt. % to 25 wt. %), 1 wt. % to 40 wt. % Na₂O (e.g., 5 wt. % to 30 wt. %, 8 wt. % to 20 wt. %, or 10 wt. % to 15 wt. %), 0 wt. % to 10 wt. % Al₂O₃ (1 wt. % to 7 wt. % or 2 wt. % to 5 wt. %), 10 wt. % to 60 wt. % SiO₂ (e.g., 20 wt. % to 55 wt. %, 30 wt. % to 50 wt. % or 40 wt. % to 48 wt. %), 1 wt. % to 15 wt. % K₂O (1 wt. % to 10 wt. % or 2 wt. % to 5 wt. %), 1 wt. % to 12 wt. % CaO (e.g., 1 wt. % to 10 wt. % or 2 wt. % to 5 wt. %), 1 wt. % to 15 wt. % ZnO (e.g., 2 wt. % to 12 wt. % or 5 wt. % to 10 wt. %), 0 wt. % to 30 wt. % Bi₂O₃ (e.g., 5 wt. % to 25 wt. % or 10 wt. % to 20 wt. %), 0 wt. % to 30 wt. % V₂O₅ (e.g., 5 wt. % to 25 wt. % or 10 wt. % to 20 wt. %), 0 wt. % to 5 wt. % F (e.g., 1 wt. % to 4 wt. % or 2 wt. % to 3 wt. %), and 0 wt. % to 5 wt. % F TiO₂ (e.g., 1 wt. % to 4 wt. % or 2 wt. % to 3 wt. %). The at least one glass frit may be present as a mixture of Li₂O, B₂O₃, Na₂O, Al₂O₃, SiO₂, K₂O, CaO, and ZnO. The glass frit mixture may have a weight percentage of each glass frit present in the mixture, based on the total weight of the glass frit mixture, of 5.13 wt. % Li₂O, 21.80 wt. % B₂O₃, 10.50 wt. % Na₂O, 3.07 wt. % Al₂O₃, 46.20 wt. % SiO₂, 2.80 wt. % K₂O, 3.26 wt. % CaO, and 7.23 wt. % ZnO.

Based on the total weight of solid components of the pre-ceramic polymer composition, the at least one glass frit may be present at a percent by weight of 1 wt. % to 65 wt. % (e.g., 5 wt. % to 65 wt. %, 10 wt. % to 55 wt. %, 35 wt. % to 55 wt. %, 45 wt. % to 55 wt. %, or 35 wt. % to 45 wt. %).

Based on the total weight of the pre-ceramic polymer composition, the at least one glass frit may be present at a percent by weight of 0.5 wt. % to 60 wt. % (e.g., 1 wt. % to 60 wt. %, 2 wt. % to 55 wt. %, 5 wt. % to 50 wt. %, 9 wt. % to 50 wt. %, 33 wt. % to 50 wt. %, 42 wt. % to 50 wt. %, or 33 wt. % to 42 wt. %).

The at least one solvent may be a solvent or solvent mixture commonly used in coating formulation that ensures efficient mixing, surface wetting, coating application, and defect-free film formation. The at least one solvent may comprise, consists of, or consists essentially of 1-butanol, n-propanol, isobutanol, isopropanol, n-pentanol, 2-methyl butanol, sec-butyl alcohol, isobutyl alcohol, butyl CELLOSOLVE solvent (ethylene glycol n-butyl ether), isopropyl acetate, butyl acetate, methyl ethyl ketone, methyl isobutyl ketone, xylene, UCAR n propyl propionate, UCAR n-pentyl propionate, toluene, VM & P™ Naphtha, Aromatic 100, parachlorobenzotrifluoride (PCBTF), Mineral Spirits 66/3, or a combination thereof. The solvent may be a mixture of a polar solvent A and a non-polar solvent B, wherein solvent A is selected from the group consisting of 1-butanol, n-propanol, isobutanol, isopropanol, n-pentanol, 2-methyl butanol, sec-butyl alcohol, isobutyl alcohol, butyl CELLOSOLVE solvent (ethylene glycol n-butyl ether), isopropyl acetate, butyl acetate, methyl ethyl ketone, methyl isobutyl ketone or a combination thereof, and solvent B is selected from the group consisting of xylene, UCAR n propyl propionate, UCAR n-pentyl propionate, toluene, VM & P™ Naphtha, Aromatic 100, parachlorobenzotrifluoride (PCBTF), Mineral Spirits 66/3, or a combination thereof; wherein, solvent A is in the range of 5 wt. % to 30 wt. % (e.g., 10 wt. % to 25 wt. % or 15 wt. % to 20 wt. %) of the solvent mixture and solvent B is in the range of 70 wt. % to 95 wt. % (e.g., 75 wt. % to 90 wt. % or 80 wt. % to 85 wt. %) of the solvent mixture. The at least one solvent may be a mixture of 1-butanol and xylene; wherein the ratio of 1-butanol to xylene may be present in a ratio of 1:19 to 1:1 (e.g., 1:10 to 1:1, 1:10 to 4:6, 1:10 to 3:7, 1:10 to 2:8, 2:8 to 1:1, 2:8 to 4:6, 2:8 to 3:7, 3:7 to 1:1, 3:7 to 4:6, or 4:6 to 1:1). The at least one solvent may be a mixture of 1-butanol and xylene, wherein the ration of 1-butanol to xylene may be present in a ratio of 1:10.

Based on the total weight of the pre-ceramic polymer composition, the at least one solvent is present at a percent by weight of 0 wt. % to 20 wt. % (e.g., 0 wt. % to 15 wt. %, 0 wt. % to 10 wt. %, 4 wt. % to 10 wt. %, 4 wt. % to 7 wt. %, or 5 wt. % to 7 wt. %).

The thermal treatment of the coated substrate may be conducted at a temperature range of 400° C. to 1400° C. (e.g., 400° C. to 1000° C., 400° C. to 900° C., 400° C. to 800° C., 400° C. to 600° C., 600° C. to 800° C., 800° C. to 1000° C., 427° C. to 1000° C., 427° C. to 900° C., 427° C. to 760° C., 427° C. to 538° C., 538° C. to 760° C., 538° C. to 900° C. 760° C. to 1000° C., 427° C., 538° C., 760° C., 800° C., or 1000° C.). The thermal treatment may comprise first treating the coated substrate at a moderately elevated temperature and then treating the coated substrate at a high temperature. The thermal treatment may comprise first treating the coated substrate at a temperature in the range of 60° C. to 120° C. (e.g., 65° C. to 110° C., 70° C. to 100° C., 75° C. to 95° C., 80° C. to 90° C., or 80° C.) and then treating the coated substrate at a higher temperature in the range of 200° C. to 1400° C. (e.g., 200° C. to 1000° C., 400° C. to 1000° C., 400° C. to 900° C., 400° C. to 800° C., 400° C. to 600° C., 600° C. to 800° C., 800° C. to 1000° C., 427° C. to 1000° C., 427° C. to 900° C., 427° C. to 760° C., 427° C. to 538° C., 538° C. to 760° C., 538° C. to 900° C., 760° C. to 1000° C., 427° C., 538° C., 760° C., 800° C., or 1000° C.). The thermal treatment of the coated substrate may be conducted for at least 20 minutes (e.g., for 20 minutes, for at least 30 minutes, for 30 minutes, for at least 1 hour, for 1 hour, for at least 2 hours, for 2 hours, for at least 4 hours, for 4 hours, for at least 6 hours, for 6 hours, for at least 8 hours, or for 8 hours).

The thermal treatment may be open-to-air. The method may further comprise drying the coated substrate at ambient conditions prior to thermal treatment. The method may further comprise forcing drying the coated substrate prior to thermal treatment. The method may further comprise drying the coated substrate at ambient conditions for at least 1 minute (e.g., for 1 minute, for at least 5 minutes, for 5 minutes, for at least 10 minutes, for 10 minutes, for 15 minutes, for at least 30 minutes, for 30 minutes, for at least 1 hour, for 1 hour, for at least 2 hours, or for 2 hours) and then forcing dried at a temperature of at least 60° C. (e.g., at least 70° C., at least 80° C., at least 90° C., at least 100° C., at least 110° C., or at least 120° C.) for at least 5 minutes (e.g., for 5 minutes, for at least 10 minutes, for 10 minutes, for 15 minutes, for at least 30 minutes, for 30 minutes, for at least 1 hour, for 1 hour, for at least 2 hours, or for 2 hours) prior to thermal treatment. The method may further comprise drying the coated substrate at ambient conditions in the range of 1 minutes to 30 minutes and then forcing dried at a temperature in the range of 60° C. to 120° C. for a time in the range of 5 minutes to 1 hour prior to thermal treatment. The thermal treatment may cause the at least one glass frit to plasticize the metal-oxide-impregnated polymer-derived ceramic.

The metal-oxide-impregnated polymer-derived ceramic may be amorphous. The metal-oxide-impregnated polymer-derived ceramic may be partially crystalline. The metal-oxide-impregnated polymer-derived ceramic may be a SiCₓO₂₍₁₋ₓ₎+yC_{free} ceramic, wherein x is selected from the range of 0 to 1, C_{free} is the amount of free carbon present in the coating matrix, and y is selected from the range 0 to 1. The metal-oxide-impregnated polymer-derived ceramic may be a silicon oxycarbide (SiOC) ceramic. The metal-oxide-impregnated polymer-derived ceramic may be an SiOC glassy ceramic. The metal-oxide-impregnated polymer-derived ceramic may be SiOC, SiO₄, SiO₃C, SiO₂C₂, SiOC₃, SiC₄, or other similar structures. The metal-oxide-impregnated polymer-derived ceramic may contain free carbon. The metal-oxide-impregnated polymer-derived ceramic may be SiOC, SiO₄, SiO₃C, SiO₂C₂, SiOC₃, SiC₄, or other similar structures, wherein the C may be from a free carbon source. The metal-oxide-impregnated polymer-derived ceramic may be any combination of the structure units Si, O, and/or C. The crosslinking and pyrolysis of the at least one silicone resin to prepare the metal-oxide-impregnated polymer-derived ceramic may form the SiCₓO₂₍₁₋ₓ₎+yC_{free} ceramic structure with units SiOC, SiO₄, SiO₃C, SiO₂C₂, SiOC₃, SiC₄, or other similar structures. The combination of the crosslinking and pyrolysis with the metal oxides compensates shrinkage and improves the film properties. The metal-oxide-impregnated polymer-derived ceramic may be mixed with the at least one glass frit.

The pre-ceramic polymer composition may be applied to the substrate using at least one selected from the group consisting of drawdown bar applicator, spraying, dip-coating, brushing, painting, and any other method known in the art. The pre-ceramic polymer composition may be applied to the substrate using drawdown bar applicator. The pre-ceramic polymer composition may be painted on the substrate, open to air.

The pre-ceramic polymer composition may be applied so that the coating has a thickness in the range of 10 μm to 500 μm (e.g., 50 μm to 500 μm, 100 μm to 400 μm, 150 μm to 350 μm, or 200 μm to 300 μm). The pre-ceramic polymer composition may be applied so that the coating has a thickness of 203 μm.

The metal-oxide-impregnated polymer-derived ceramic may form a final coherent and adherent thin film; wherein the film has an average thickness of 5 μm to 300 μm (e.g., 10 μm to 250 μm, 25 μm to 200 μm, 50μ m to 150 μm, 50 μm to 100 μm, or 50 μm to 75 μm). The film may have an average thickness of 56 μm.

Substrates Coated with A Metal-Oxide-Impregnated Polymer-Derived Ceramic Coating

### The Disclosure Also Relates to a Coated Substrate, Comprising, Consisting of, or Consisting Essentially of:

a metal substrate; and
a metal-oxide-impregnated polymer-derived ceramic coating comprising at least one metal oxide, metal hydroxide, and/or metal oxyhydroxide, and at least one glass frit.

### The Disclosure Also Relates to a Coated Substrate, Comprising, Consisting of, or Consisting Essentially of:

a substrate; and
a metal-oxide-impregnated polymer-derived ceramic coating comprising at least one metal oxide, metal hydroxide, and/or metal oxyhydroxide, and at least one glass frit.

### The Disclosure Also Relates to a Coating Film, Comprising, Consisting of, or Consisting Essentially of:

a metal-oxide-impregnated polymer-derived ceramic coating comprising at least one metal oxide, metal hydroxides, and/or metal oxyhydroxide, and at least one glass frit.

The substrate may be a metal substrate. The substrate may be an inert substrate. The coating film may further comprise a metal substrate. The coating film may further comprise an inert substrate. The inert substrate may be a ceramic substrate that is able to withstand high temperatures (e.g., magnesium oxide, zirconia, platinum, or silicone carbide). The metal oxide-impregnated polymer-derived ceramic may be a free-standing film. The metal substrate may further comprise at least one metal and optionally, at least one metal oxide, metal hydroxide, and/or metal oxyhydroxide. The at least one metal may comprise, consist of, or consist essentially of metal oxides, metal hydroxides, and/or metal oxyhydroxides. The metal oxides, metal hydroxides, and/or metal oxyhydroxides may grow by the reaction of the at least one metal with ambient oxygen diffused into the interface of the pre-ceramic polymer composition and metal-oxide-impregnated polymer-derived ceramic through the coating process. The oxygen may continue diffusing into the pre-ceramic polymer composition/metal-oxide-impregnated polymer-derived ceramic (during polymer-derived ceramic conversion). At least one metal ion may continue diffusing into the pre-ceramic polymer composition/metal-oxide-impregnated polymer-derived ceramic (during polymer-derived ceramic conversion). The at least one metal oxide may continue growing until the ceramic film is well formed. Then the oxygen may slowly stop diffusing into the metal-oxide-impregnated polymer-derived ceramic and the at least one metal ion may slowly stop diffusing into metal-oxide-impregnated polymer-derived ceramic as the ceramic film is fully converted from the pre-ceramic polymer composition to the polymer-derived ceramic. The at least one metal oxide may be iron oxides, aluminum oxides, copper oxides, titanium oxides, magnesium oxides, nickel oxides, or combinations thereof. The metal oxides may comprise, consist of, or consist essentially of metal oxides, metal hydroxides, and/or metal oxyhydroxides. The at least one metal oxide may be a metal powder. The metal powder may comprise, consist of, or consist essentially of metal oxides, metal hydroxides, metal oxyhydroxides, or combinations thereof. The at least one powder may be an iron powder, an aluminum powder, a copper powder, a titanium powder, a magnesium powder, a nickel powder, or a combinations thereof. The metal powder may be a metal oxide powder; wherein the metal oxide powder is an iron oxide powder, an aluminum oxide powder, a copper oxide powder, a titanium oxide powder, a magnesium oxide powder, a nickel oxide powder, or combinations thereof. The metal oxides may form a metal oxide film on the substrate. The coated substrate may further comprise at least one metal powder. The coating film may further comprise at least one metal powder. The metal-oxide-impregnated polymer-derived ceramic coating may further comprise at least one metal powder.

The metal-oxide-impregnated polymer-derived ceramic coating may be amorphous. The metal-oxide-impregnated polymer-derived ceramic may be partially crystalline. The metal-oxide-impregnated polymer-derived ceramic may be a SiCₓO₂₍₁₋ₓ₎+yC_{free} ceramic, wherein x is selected from the range of 0 to 1, C_{free} is the amount of free carbon present in the coating matrix, and y is selected from the range 0 to 1. The metal-oxide-impregnated polymer-derived ceramic may be a silicon oxycarbide (SiOC) ceramic. The metal-oxide-impregnated polymer-derived ceramic may be an SiOC glassy ceramic. The metal-oxide-impregnated polymer-derived ceramic may be SiOC, SiO₄, SiO₃C, SiO₂C₂, SiOC₃, SiC₄, or other similar structures. The metal-oxide-impregnated polymer-derived ceramic may contain free carbon. The metal-oxide-impregnated polymer-derived ceramic may be SiOC, SiO₄, SiO₃C, SiO₂C₂, SiOC₃, SiC₄, or other similar structures, wherein the C may be from a free carbon source. The metal-oxide-impregnated polymer-derived ceramic may be any combination of the structure units of Si, O, and/or C. The metal-oxide-impregnated polymer-derived ceramic may be mixed with the at least one glass frit.

The at least one glass frit may have a melting point below 450° C. (e.g., below 427° C., below 400° C., below 350° C., below 300° C., below 250° C.). The at least one glass frit may have a melting point in the range of 200° C. to 450° C. (e.g., 200° C. to 427° C., 200° C. to 400° C., 200° C. to 350° C., 200° C. to 300° C., 200° C. to 250° C., 250° C. to 427° C., 250° C. to 400° C., 250° C. to 350° C., 250° C. to 300° C., 300° C. to 427° C., 300° C. to 400° C., 300° C. to 350° C., 350° C. to 427° C., 350° C. to 400° C., or 400° C. to 450° C.). The at least one glass frit may have a melting point in the range of 200° C. to 800° C. (e.g., 250° C. to 700° C., 300° C. to 600° C., or 350° C. to 500° C.). The at least one glass frit may comprise, consists of, or consists essentially of Li₂O, B₂O₃, Na₂O, Al₂O₃, SiO₂, K₂O, CaO, ZnO, Bi₂O₃, V₂O₅, F, TiO₂, or a combination comprising two or more thereof. The glass frit mixture may have a weight percentage of each glass frit present in the mixture, based on the total weight of the glass frit mixture, of 1 wt. % to 10 wt. % Li₂O (e.g., 1 wt. % to 9 wt. %, 2 wt. % to 8 wt. %, 3 wt. % to 7 wt. %, or 4 wt. % to 6 wt. %), 1 wt. % to 50 wt. % B₂O₃ (e.g., 5 wt. to 45 wt. %, 10 wt. % to 40 wt. %, 15 wt. % to 35 wt. %, or 20 wt. % to 25 wt. %), 1 wt. % to 40 wt. % Na₂O (e.g., 5 wt. % to 30 wt. %, 8 wt. % to 20 wt. %, or 10 wt. % to 15 wt. %), 0 wt. % to 10 wt. % Al₂O₃ (1 wt. % to 7 wt. % or 2 wt. % to 5 wt. %), 10 wt. % to 60 wt. % SiO₂ (e.g., 20 wt. % to 55 wt. %, 30 wt. % to 50 wt. % or 40 wt. % to 48 wt. %), 1 wt. % to 15 wt. % K₂O (1 wt. % to 10 wt. % or 2 wt. % to 5 wt. %), 1 wt. % to 12 wt. % CaO (e.g., 1 wt. % to 10 wt. % or 2 wt. % to 5 wt. %), 1 wt. % to 15 wt. % ZnO (e.g., 2 wt. % to 12 wt. % or 5 wt. % to 10 wt. %), 0 wt. % to 30 wt. % Bi₂O₃ (e.g., 5 wt. % to 25 wt. % or 10 wt. % to 20 wt. %), 0 wt. % to 30 wt. % V₂O₅ (e.g., 5 wt. % to 25 wt. % or 10 wt. % to 20 wt. %), 0 wt. % to 5 wt. % F (e.g., 1 wt. % to 4 wt. % or 2 wt. % to 3 wt. %), and 0 wt. % to 5 wt. % F TiO₂ (e.g., 1 wt. % to 4 wt. % or 2 wt. % to 3 wt. %). The at least one glass frit may be present as a mixture of Li₂O, B₂O₃, Na₂O, Al₂O₃, SiO₂, K₂O, CaO, and ZnO. The glass frit mixture may have a weight percentage of each glass frit present in the mixture, based on the total weight of the glass frit mixture, of 5.13 wt. % Li₂O, 21.80 wt. % B₂O₃, 10.50 wt. % Na₂O, 3.07 wt. % Al₂O₃, 46.20 wt. % SiO₂, 2.80 wt. % K₂O, 3.26 wt. % CaO, and 7.23 wt. % ZnO.

The metal substrate may comprise, consist of, or consist essentially of iron or alloys thereof (e.g., steel or stainless steel), aluminum or alloys thereof, copper or alloys thereof, titanium or alloys thereof, magnesium or alloys thereof, nickel or alloys thereof, and combinations thereof. The metal substrate may be free of rust, corrosion, or a metal oxide film. The metal substrate may contain metal oxides. The metal oxides may be iron oxides, aluminum oxides, copper oxides, titanium oxides, magnesium oxides, nickel oxides, or combinations thereof. The metal oxides may comprise, consist of, or consist essentially of metal oxides, metal hydroxides, and/or metal oxyhydroxides. The metal oxides may form a metal oxide film on the metal substrate. The metal substrate may comprise, consist of, or consist essentially of iron and/or steel; wherein the iron and/or steel substrate may contain rust (e.g., metal oxide film); wherein the rust may comprise, consists of, or consists essentially of metal oxides; wherein the metal oxides of the rust are iron oxides; wherein the iron oxides may be iron oxides, iron hydroxides, and/or iron oxyhydroxides; wherein thermal treatment may cause a film of rust (e.g., metal oxide film) to form at the interface between the metal-oxide-impregnated polymer-derived ceramic and metal substrate; and wherein thermal treatment may cause the iron oxides and/or iron oxyhydroxides from the rust film to diffuse into the coating matrix. The metal-oxide-impregnated polymer-derived ceramic coating may be crack-free. The rust may be present on the metal substrate prior to the formation of the metal-oxide-impregnated polymer-derived ceramic coating. The metal oxide film may grow on the metal substrate from non-existence. At least a portion of the metal substrate may contain the metal oxide film (e.g., rust film) at the interface between the metal-oxide-impregnated polymer-derived ceramic and the metal substrate.

The metal-oxide-impregnated into the polymer-derived ceramic may comprises, consist of, or consist essentially of FeO, Fe₂O₃, Fe₃O₄, Fe(OH)₂, Fe(OH)₃, FeOOH, or a combination comprising two or more thereof. The metal-oxide-impregnated into the polymer-derived ceramic may comprise, consist of, or consist essentially of FeO, Fe₂O₃, Fe₃O₄, FeOOH, or a combination comprising two or more thereof. The metal oxide layer may comprise, consist of, or consist essentially of distinct layers on top of iron; wherein the distinct layers may be FeO, Fe₃O₄, and Fe₂O₃. The metal oxide layer may be distinct under the metal-oxide impregnated polymer-derived ceramic.

The substrate may be at least partially coated with the a metal-oxide-impregnated polymer-derived ceramic coating. The substrate may be fully coated with the a metal-oxide-impregnated polymer-derived ceramic coating.

The metal-oxide-impregnated polymer-derived ceramic may have a coherent and adherent thin film; wherein the film has an average thickness of 5 μm to 300 μm (e.g., 10 μm to 250 μm, 25 μm to 200 μm, 50 μm to 150 μm, 50 μm to 100 μm, or 50 μm to 75 μm). The film may have an average thickness of 56 μm.

Articles of Manufacture Coated with A Metal-Oxide-Impregnated Polymer-Derived Ceramic Coating

The invention also relates to an article of manufacture comprising an object, wherein at least a portion of at least one surface of the object is the coated substrate of the disclosure. The coated substrate may comprise, consist of, or consist essentially of a metal substrate comprising at least one metal, and at least one metal oxide and/or metal oxyhydroxide; and a metal-oxide-impregnated polymer-derived ceramic coating comprising the metal oxide and/or metal oxyhydroxide from the metal substrate, and at least one glass frit.

The invention also relates to an article of manufacture comprising an object, where at least a portion of at least one surface of the object comprises the coating film of the disclosure. The coating film, comprising, consisting of, or consisting essentially of: at least one metal comprising at least one metal oxide and/or metal oxyhydroxide; and a metal-oxide-impregnated polymer-derived ceramic coating comprising the metal oxide and/or metal oxyhydroxide from the metal substrate, and at least one glass frit.

The invention also relates to an article of manufacture comprising the coating film of the disclosure.

The object may be a flare stack (crude oil), a smoke stack (large ships), an exhaust pipe for vehicles, a military gun barrel, an aircraft landing fear (friction and heat), or the like.

### Exemplary Embodiments of the Invention

E1. A method for preparing a corrosive-resistant product, comprising, consists of, or consists essentially of:
   coating a metal substrate with a pre-ceramic polymer composition comprising at least one silicone resin, at least one glass frit dispersed in the silicone resin, and optionally at least one solvent, wherein the metal substrate is at least partially coated; and subjecting the coated metal substrate to thermal treatment to diffuse metal oxides from the metal substrate into a coating matrix and induce crosslinking and pyrolysis of the at least one silicone resin to prepare a metal-oxide-impregnated polymer-derived ceramic.
E2. The method of E1, wherein the metal substrate comprises iron or steel, and wherein the metal oxides comprise iron oxides, iron hydroxides, and/or iron oxyhydroxides.
E3. The method of E1 or E2, wherein the at least one silicone resin comprises, consists of, or consists essentially of a polysiloxane resin, a polycarbosiloxane resin, a polycarbosilane resin, a polycarbodiimide resin, a polysilazane resin, a polyborosilazane resin, a polyborosilane resin, a polyborosiloxane resin, or a combination comprising two or more thereof.
E4. The method of any one of E1 to E3, wherein the at least one silicone resin comprises, consists of, or consists essentially of a polysiloxane resin.
E5. The method of any one of E1 to E4, wherein the at least one silicone resin comprises, consists of, or consists essentially of poly(methylphenylsiloxane).
E6. The method of any one of E1 to E5, wherein the at least one silicone resin has a viscosity of 3000 mPas at 25° C.
E7. The method of any one of E1 to E6, wherein the at least one silicone resin is Silikophen P 80/X.
E8. The method of any one of E1 to E7, wherein based on the total weight of the pre-ceramic polymer composition, the at least one silicone resin is present in an amount of 30 wt. % to 95 wt. %.
E9. The method of any one of E1 to E8, wherein based on the total weight of the pre-ceramic polymer composition, the at least one silicone resin is present at a percent by weight of 40 wt. % to 70 wt. %.
E10. The method of any one of E1 to E9, wherein based on the total weight of the pre-ceramic polymer composition, the at least one silicone resin is present at a percent by weight of 40 wt. % to 62 wt. %.
E11. The method of any one of E1 to E10, wherein based on the total weight of the pre-ceramic polymer composition, the at least one silicone resin is present at a percent by weight of 40 wt. % to 52 wt. %.
E12. The method of any one of E1 to E11, wherein the at least one glass frit has a melting point below 450° C.
E13. The method of any one of E1 to E12, wherein the at least one glass frit comprises, consists of, or consists essentially of Li₂O, B₂O₃, Na₂O, Al₂O₃, SiO₂, K₂O, CaO, ZnO, Bi₂O₃, V₂O₅, F, TiO₂, or a combination comprising two or more thereof.
E14. The method of E13, wherein the at least one glass frit is a mixture of Li₂O, B₂O₃, Na₂O, Al₂O₃, SiO₂, K₂O, CaO, and ZnO.
E15. The method of E14, wherein the glass frit mixture has a weight percentage of each glass frit present in the mixture, based on the total weight of the glass frit mixture, of 5.13 wt. % Li₂O, 21.80 wt. % B₂O₃, 10.50 wt. % Na₂O, 3.07 wt. % Al₂O₃, 46.20 wt. % SiO₂, 2.80 wt. % K₂O, 3.26 wt. % CaO, and 7.23 wt. % ZnO.
E16. The method of any one of E1 to E15, wherein based on the total weight of solid components of the pre-ceramic polymer composition, the at least one glass frit is present at a percent by weight of 1 wt. % to 65 wt. %.
E17. The method of any one of E1 to E16, wherein based on the total weight of solid components of the pre-ceramic polymer composition, the at least one glass frit is present at a percent by weight of 35 wt. % to 55 wt. %.
E18. The method of any one of E1 to E17, wherein based on the total weight of solid components of the pre-ceramic polymer composition, the at least one glass frit is present at a percent by weight of 45 wt. % to 55 wt. %.
E19. The method of any one of E1 to E17, wherein based on the total weight of solid components of the pre-ceramic polymer composition, the at least one glass frit is present at a percent by weight of 35 wt. % to 45 wt. %.
E20. The method of any one of E1 to E19, wherein based on the total weight of the pre-ceramic polymer composition, the at least one glass frit is present at a percent by weight of 0.5 wt. % to 60 wt. %.
E21. The method of any one of E1 to E20, wherein based on the total weight of the pre-ceramic polymer composition, the at least one glass frit is present at a percent by weight 9 wt. % to 50 wt. %.
E22. The method of any one of E1 to E21, wherein based on the total weight of the pre-ceramic polymer composition, the at least one glass frit is present at a percent by weight of 33 wt. % to 50 wt. %.
E23. The method of any one of E1 to E22, wherein based on the total weight of the pre-ceramic polymer composition, the at least one glass frit is present at a percent by weight of 42 wt. % to 50 wt. %.
E24. The method of any one of E1 to E22, wherein based on the total weight of the pre-ceramic polymer composition, the at least one glass frit is present at a percent by weight of 33 wt. % to 42 wt. %.
E25. The method of any one of E1 to E24, wherein the at least one solvent comprises, consists of, or consists essentially of 1-butanol, xylene, n-propanol, isobutanol, isopropanol, n-pentanol, 2-methyl butanol, sec-butyl alcohol, isobutyl alcohol, butyl CELLOSOLVE solvent (ethylene glycol n-butyl ether), isopropyl acetate, butyl acetate, methyl ethyl ketone, methyl isobutyl ketone, xylene, UCAR n propyl propionate, UCAR n-pentyl propionate, toluene, VM & P™ Naphtha, Aromatic 100, parachlorobenzotrifluoride (PCBTF), Mineral Spirits 66/3, or a combination thereof.
E26. The method of E25, wherein the at least one solvent is a mixture of 1-butanol and xylene.
E27. The method of E26, wherein the ratio of 1-butanol and xylene is present in a ratio of 1:19 to 1:1.
E28. The method of any one of E1 to E27, wherein based on the total weight of the pre-ceramic polymer composition, the at least one solvent is present at a percent by weight of 0 wt. % to 20 wt. %.
E29. The method of any one of E1 to E28, based on the total weight of the pre-ceramic polymer composition, the at least one solvent is present at a percent by weight of 4 wt. % to 10 wt. %.
E30. The method of any one of E1 to E29, based on the total weight of the pre-ceramic polymer composition, the at least one solvent is present at a percent by weight of 4 wt. % to 7 wt. %.
E31. The method of any one of E1 to E30, based on the total weight of the pre-ceramic polymer composition, the at least one solvent is present at a percent by weight of 5 wt. % to 7 wt. %.
E32. The method of any one of E1 to E31, wherein the thermal treatment of the coated metal substrate is conducted at a temperature range of 200° C. to 1400° C.
E33. The method of any one of E1 to E32, wherein the thermal treatment of the coated metal substrate is conducted at a temperature range of 400° C. to 1000° C.
E34. The method of any one of E1 to E33, wherein the thermal treatment of the coated metal substrate is conducted at a temperature range of 427° C. to 760° C.
E35. The method of any one of E1 to E34, wherein the thermal treatment of the coated metal substrate is conducted at a temperature range of 427° C. to 538° C.
E36. The method of any one of E1 to E34, wherein the thermal treatment of the coated metal substrate is conducted at a temperature range of 538° C. to 760° C.
E37. The method of any one of E1 to E36, wherein the thermal treatment comprises first treating the coated metal substrate at a moderately elevated temperature and then treating the coated metal substrate at a high temperature.
E38. The method of E37, wherein the thermal treatment comprises first treating the coated metal substrate at 60° C. to 120° C. and then treating the coated metal substrate at a higher temperature in the range of 200° C. to 1400° C.
E39. The method of E38, wherein the thermal treatment comprises first treating the coated metal substrate at 60° C. to 120° C. and then treating the coated metal substrate at a higher temperature in the range of 400° C. to 900° C.
E40. The method of E39, wherein the thermal treatment comprises first treating the coated metal substrate at 60° C. to 120° C. and then treating the coated metal substrate at a higher temperature in the range of 538° C. to 760° C.
E41. The method of any one of E1 to E40, wherein the thermal treatment of the coated metal substrate is conducted for at least 1 hour.
E42. The method of any one of E1 to E41, wherein the thermal treatment is open-to-air.
E43. The method of any one of E1 to E42, further comprising drying the coated metal substrate at ambient conditions for at least 1 minute and then forcing dried at a range of 60° C. to 120° C. for at least 5 minutes prior to thermal treatment.
E44. The method of any one of E1 to E43, wherein the metal-oxide-impregnated polymer-derived ceramic is amorphous.
E45. The method of any one of E1 to E43, wherein the metal-oxide-impregnated polymer-derived ceramic is partially crystalline.
E46. The method of any one of E1 to E45, wherein the metal-oxide-impregnated polymer-derived ceramic is a SiCₓO₂₍₁₋ₓ₎+yC_{free} ceramic, wherein x is selected from the range of 0 to 1, C_{free} is the amount of free carbon present in the coating matrix, and y is selected from the range 0 to 1.
E47. The method of any one of E1 to E46, wherein the metal-oxide-impregnated polymer-derived ceramic is a silicon oxycarbide (SiOC) glassy ceramic.
E48. The method of any one of E1 to E47, wherein the metal-oxide-impregnated polymer-derived ceramic contains free carbon.
E49. The method of any one of E1 to E48, wherein the thermal treatment causes a film of rust to form at the interface between the metal-oxide-impregnated polymer-derived ceramic and metal substrate.
E50. The method of E49, wherein thermal treatment causes the metal oxides from the rust film to diffuse into the coating matrix.
E51. The method of any one of E1 to E50, wherein the metal-oxide-impregnated into the polymer-derived ceramic comprises FeO, Fe₂O₃, Fe₃O₄, Fe(OH)₂, Fe(OH)₃, FeOOH, or a combination comprising two or more thereof.
E52. The method of any of E1 to E51, wherein the thermal treatment causes the at least one glass frit to plasticize the coating.
E53. The method of any one of E1 to E52, wherein the pre-ceramic polymer composition is applied to the metal substrate using at least one selected from the group consisting of drawdown bar applicator, spraying, dip-coating, painting, and brushing.
E54. The method of any one of E53, wherein the pre-ceramic polymer composition is applied to the metal substrate using drawdown bar applicator.
E55. The method of any one of E1 to E54, wherein the pre-ceramic polymer composition is applied so that the coating has a thickness of 10 μm to 500 μm.
E56. A coated substrate, comprising:
   a metal substrate; and
   a metal-oxide-impregnated polymer-derived ceramic coating comprising at least one metal oxide, metal hydroxide, and/or metal oxyhydroxide, and at least one glass frit.
E57. The coated substrate of E56, wherein the metal substrate comprise, consists of, or consists essentially of at least one metal, and optionally, at least one metal oxide, metal hydroxide, and/or metal oxyhydroxide.
E58. The coated substrate of E56 or E57, wherein the metal-oxide-impregnated polymer-derived ceramic coating is amorphous.
E59. The coated substrate of any one of E56 to E58, wherein the metal-oxide-impregnated polymer-derived ceramic is partially crystalline.
E60. The coated substrate of any one of E56 to E59, wherein the metal-oxide-impregnated polymer-derived ceramic is a SiCₓO₂₍₁₋ₓ₎+yC_{free} ceramic, wherein x is selected from the range of 0 to 1, C_{free} is the amount of free carbon present in the coating matrix, and y is selected from the range 0 to 1.
E61. The coated substrate one of any of E56 to E60, wherein the metal-oxide-impregnated polymer-derived ceramic is a silicon oxycarbide (SiOC) glassy ceramic.
E62. The coated substrate of any one of E56 to E61, wherein the metal-oxide-impregnated polymer-derived ceramic contains free carbon.
E63. The coated substrate of any one of E56 to E62, wherein the at least one glass frit has a melting point below 450° C.
E64. The coated substrate of any one of E56 to E63, wherein the at least one glass frit comprises Li₂O, B₂O₃, Na₂O, Al₂O₃, SiO₂, K₂O, CaO, ZnO, Bi₂O₃, V₂O₅, F, TiO₂, or a combination comprising two or more thereof.
E65. The coated substrate of E64, wherein the at least one glass frit is a mixture of Li₂O, B₂O₃, Na₂O, Al₂O₃, SiO₂, K₂O, CaO, and ZnO.
E66. The coated substrate of E65, wherein the glass frit mixture has a weight percentage of each glass frit present in the mixture, based on the total weight of the glass frit mixture, of 5.13 wt. % Li₂O, 21.80 wt. % B₂O₃, 10.50 wt. % Na₂O, 3.07 wt. % Al₂O₃, 46.20 wt. % SiO₂, 2.80 wt. % K₂O, 3.26 wt. % CaO, and 7.23 wt. % ZnO.
E67. The coated substrate of any one of E56 to E66, wherein the metal substrate comprises iron or steel, and wherein the metal oxides, metal hydroxides, and/or metal oxyhydroxides impregnated into the polymer-derived ceramic comprises FeO, Fe₂O₃, Fe₃O₄, Fe(OH)₂, Fe(OH)₃, FeOOH, or a combination comprising two or more thereof.
E68. An article of manufacture comprising an object, wherein at least a portion of at least one surface of the object is the coated substrate of any of E56 to E67.
E69. The article of manufacture of E68, wherein the object is selected from the group consisting of a flare stack (crude oil), smoke stack (large ships), exhaust pipe of vehicles, military gun barrels, and aircraft landing gears (friction and heat).

### Examples

### 1. Materials

Commercial glass frits (GF) were purchased from Georgies Ceramic and Clay Co., US Pigment Corporation, and New Mexico Clay. GF (Li₂O, B₂O₃, Na₂O, Al₂O₃, SiO₂, K₂O, CaO, and ZnO) were mixed to achieve oxide content for subsequent coating formulation, as shown in Table 1 below. The coating binder resin (phenyl methyl polysiloxane) used in this study is Silikophen P 80/X from Evonik. The solvent used is a mixture of 1-butanol and xylene at a 1:10 ratio, both solvents purchased from Sigma-Aldrich. The substrates used in this study were low-carbon cold-rolled steel panels (152.4 mm×76.2 mm×4.76 mm) obtained from GPI Laboratories, Inc., which were chosen due to low-cost, suitable surface preparation for coating adhesion, and being widely used for industrial components exposed to elevated temperatures. These panels were sand-blasted to SSPC-SP5 standard by the manufacturer. In addition to iron, the steel panel is composed of the following alloy elements: carbon, manganese, phosphorous, and sulfur, their maximum percentage being 0.15%, 0.60%, 0.03%, and 0.035% respectively.

### 2. Methods

### 2.1 Coating Preparation and Sample Construction

### 2.1.1 Preparation of Coating Formulations

Table 1 shows the glass frit (GF) mixture used in the present Examples.

TABLE 1
Glass frit mixture's oxide content percentage by weight.

| Oxides | Li₂O | B₂O₃ | Na₂O | Al₂O₃ | SiO₂ | K₂O | CaO | ZnO |
|---|---|---|---|---|---|---|---|---|
| Weight % | 5.13 | 21.80 | 10.50 | 3.07 | 46.20 | 2.80 | 3.26 | 7.23 |

The GF mixture shown in Table 1 was sieved to achieve a desirable particle size, then slowly added into the coating binder resin, and agitated by a high-speed disperser at 2000 rpm for 25 minutes. The coating formulations evaluated in these Examples are presented in Table 2.

TABLE 2
The composition of the hybrid coatings before
any thermal treatments or exposures.

| | | Formulation | | |
|---|---|---|---|---|
| Coating | Glass Frit Solid | Glass Frit | Binder | Solvent (1-butanol |
| Formula | Weight Percent | Mixture | Resin | and Xylene (1:10)) |
| Name | (Wt %) | (Wt %) | (Wt %) | (Wt %) |
| HC00 | 0 | 0 | 100 | 0 |
| HC35 | 35 | 33.3 | 62 | 4.7 |
| HC45 | 45 | 42 | 51.3 | 6.7 |
| HC55 | 55 | 49.7 | 40.55 | 9.75 |

### 2.1.2 Coating of Substrate Panels

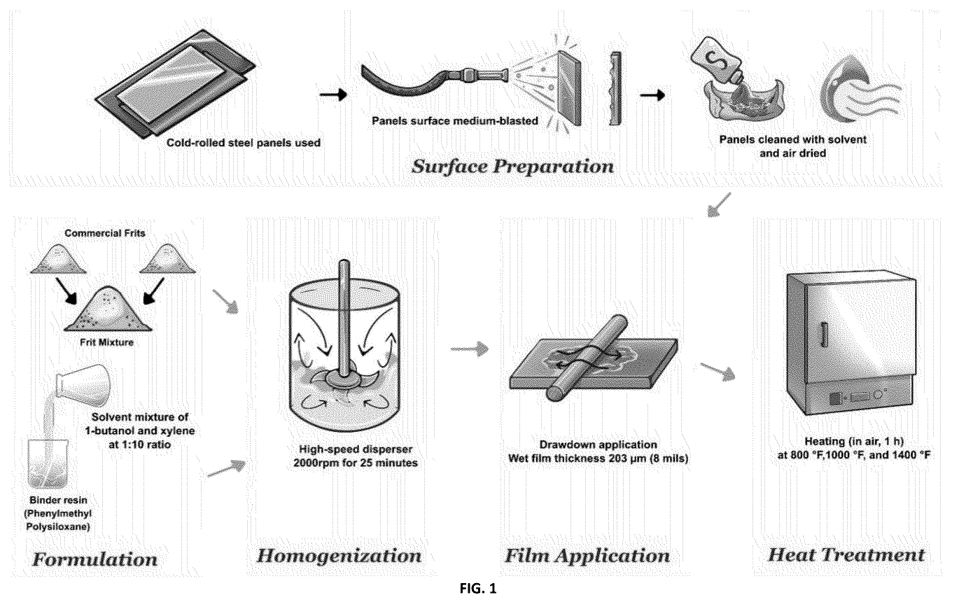

Before coating application, each panel was wiped with an acetone-soaked lint-free towel and blown dry with compressed air. Coating wet film thickness was controlled at 203 μm using a drawdown bar applicator. After their application, coatings were dried at ambient conditions for 15 minutes, followed by one hour of forced drying in an oven at 80° C. The overall experimental procedures are illustrated in FIG. 1. FIG. 1 shows a schematic of the PDC SiOC coating sample preparation process, wherein the coating samples were prepared through the following steps: 1) surface preparation by medium-blasting, cleaning, and drying, 2) preparation the glass frit filler and coating formulation, 3) homogenization of the formulation via high-speed dispersion, 4) liquid film application using a drawdown applicator, and 5) one-hour heat treatment(s) under ambient conditions.

### 2.1.3 Heat Treatment Protocol for Coated Substrate Panels

Coated panels were subjected to three elevated temperatures, 427° C., 538° C., and 760° C., to evaluate their corrosion resistance and property changes after the treatments. Panels were placed in a furnace (SentroTech ST-1200C-121216) in ambient air, heated at a heating rate of 10° C./min, held at respective target temperatures for one hour, and cooled to room temperature before further testing. Heat-treated samples were also named for simplicity, as shown in Table 3.

TABLE 3
Names of the coating samples and their corresponding
thermal treatment temperature.

| Coating | Sample names based on heat treatment temperatures | | | |
|---|---|---|---|---|
| Formula | Room | | | |
| name | temperature | 427° C.* | 538° C.† | 760° C.‡ |
| HC00 | HC00-RT | HC00-800 | HC00-1000 | HC00-1400 |
| HC35 | HC35-RT | HC35-800 | HC35-1000 | HC35-1400 |
| HC45 | HC45-RT | HC45-800 | HC45-1000 | HC45-1400 |
| HC55 | HC55-RT | HC55-800 | HC55-1000 | HC55-1400 |

*800° F.:
†1000° F.:
‡1400° F.

### 2.2 Characterization

### 2.2.1 Spectroscopic Characterization of Coated Panels

Fourier transform infrared spectroscopy (FTIR) was conducted with a KBr window on a Thermo Scientific Nicolet 8700 Fourier Transform Infrared Spectrometer to investigate the chemical structure evolution during the coating's SiOC conversion. The spectra were recorded over the 400-4000 cm⁻¹ range with a resolution of 4 cm⁻¹, averaging 64 scans for each measurement. Raman spectroscopy was used to characterize carbon contents among various phases: SiO₂, SiOxCy, SiC, and free Carbon (C_{free}) (graphitic) present in SiOC ceramic coatings, particularly the graphitic crystallinity as an indicator of the coating conversion progress. The Raman spectra of samples HC00, HC35, HC45, and HC55, treated at 427° C., 538° C., and 760° C., were recorded using a Horiba Jobin Yvons LabRAM ARAMIS confocal system. Raman spectral measurements were performed over a wavelength range of 200-3500 cm⁻¹, with a single accumulation, an acquisition time of 1000 ms, and a 532 nm laser source. X-ray Diffraction (XRD), used to characterize crystalline and semi-crystalline structures, was performed on pulverized samples using a Rigaku Ultima IV Powder X-Ray Diffractometer over a 20 range from 10° to 90°. Chemical and elemental compositions were analyzed using X-ray photoelectron spectroscopy (XPS) with a K-Alpha X-ray Photoelectron Spectrometer System. The intensity of deconvoluted iron oxide peaks was used to determine the activation energy and kinetics of iron oxidation.

### 2.2.2 Characterization of Coated Panels by Evaluating Corrosion-Resistance Performance

To characterize coating performance under harsh environmental conditions and heat stress, coated panels before or after heat treatments were subjected to constant neutral salt spray (NSS) for 168 hours following ASTM B117. The combination of NSS and heat stress separates samples into 4 groups: 1) before heat treatment and NSS, 2) before heat treatment but exposed to NSS, 3) after heat treatment but before NSS, and 4) after heat treatment and exposed NSS. For samples in all 4 groups, impedance measurements were conducted with replicates taken at different locations on different panels with a Gamry Reference 600 potentiostat. Samples were kept in a grounded Faraday cage during measurements. A 3-electrode setup was used with a 3.5% NaCl aqueous solution as the electrolyte, an Ag/AgCl electrode (in a saturated potassium chloride (KCl) solution) as the reference electrode, a Niobium-coated stainless-steel mesh as the counter electrode, and an area of 1 cm² of a masked sample as the working electrode. Measurements were taken from 100,000 Hz to 0.01 Hz with a 5-10 mV (RMS) perturbation. Low-frequency impedance moduli (at 0.01 Hz) were extracted to characterize the barrier performance of these coatings. In addition, photos were taken before and after NSS exposure to visually evaluate the corrosion performance.

### 2.2.3 Characterization of Physical, Morphological, Mechanical, and Thermal Properties

Effects of thermal treatments on surface morphological change, roughness, hardness, weight loss, and PDC conversion were evaluated on a set of hybrid coatings: HC00-RT, HC55-RT, HC55-800, HC55-1000, and HC55-1400. Surface roughness was measured directly on a coating's top surface by a Keyence VR-6000 optical profilometer. Coating images from the top and cross-section views were obtained with a Keyence VHX-7000 digital microscope. The top-view images were used to analyze morphological change, and the cross-section views the film thickness. To prepare a coating for the cross-section view, it was cut into smaller samples (1 cm by 1 cm), which were embedded in an epoxy resin, and their cross-sections were exposed. After the resin was cured/hardened, the exposed cross sections were polished sequentially with 200, 800, 1200, and 2000 grit SiC abrasive paper. The embedded samples were also used for elemental mapping on a JEOL JSM-IT200LA scanning electron microscope (SEM) with an accelerating voltage of 15 keV under high-vacuum mode. To ensure surface conductivity for SEM imaging, sample cross sections were sputter-coated with a thin layer of gold (California, USA). To measure coating sample weight loss and quantify the PDC conversion, thermogravimetric analyses were conducted from ambient to 1000° C. under a nitrogen atmosphere, with a heating rate of 20° C. per minute, on a TA Q550 Suto Advanced.

Coating hardness was studied with pencil hardness and force-displacement curve analysis using a nanoindentation method. Pencil hardness was measured according to the ASTM D3363-22 method, with a set of standard pencils (Staedtler Mars Lumograph 100) having hardness from 8B to 6H. Both gouge and scratch hardness were measured following these steps: 1) sharpening the pencil core to prepare a smooth cylinder; 2) abrading the end of the pencil core with sandpaper to obtain a flat, smooth, and circular cross-section; 3) placing and holding the pencil on a leveled coating surface at a 45° angle; 4) pushing the pencil away from the operator with a minimum length of 6.5 mm; and 5) starting from the softest core (8B), repeating above steps with incremental core hardness and recording the hardness value once a visible scratch is observed. Nanoindentation or depth-sensing indentation tests were conducted on a Hysitron TriboIndenter equipped with a diamond Berkovich indenter tip and performed at a force of 2000 μN, corresponding to a measurement depth of around 200 nm to 3000 nm. Magnetism tests were conducted to further confirm the presence of iron oxide/oxyhydroxide during the PDC conversion process. Scraps of the hybrid coatings were chiseled off their surfaces and collected in small glass vials. A store-purchased magnetic bar was moved outside the glass vial to detect any magnetic response of these coating scraps.

### 3. Results

### 3.1 Coating Barrier Properties and Corrosion Performance

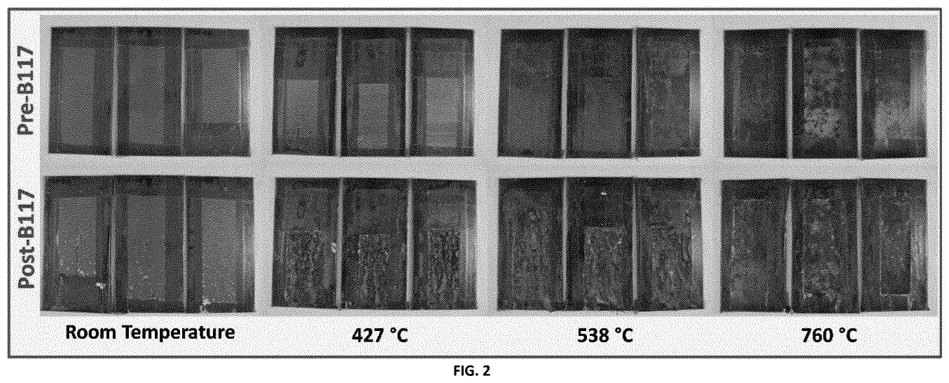

Unfilled Coatings. FIG. 2 shows photos of HC00 coatings after being treated at different temperatures and 168 hours of neutral salt spray (NSS) following ASTM B117. Photos of samples before NSS are shown in the top row of FIG. 2 and those after NSS are in the bottom row of FIG. 2. Heat treatments at 427° C. and 538° C. clearly caused coating degradation, indicated by heavy rust developed after NSS (the second and third column of the bottom row of FIG. 2). Whereas, treatment at 760° C. blackened the panel, resulting in much less surface rust than the two lower treatment temperatures. As shown in FIG. 2, the corrosion performance of unfilled coatings (HC00) were well-maintained at room temperature but deteriorated after being thermally treated at different temperatures. After NSS, samples without thermal treatment (stayed at room temperature) showed only scattered rust spots on the coating surface, especially at the lower portion of the panels, which is common due to uneven salt and corrosion product accumulation during the NSS corrosion test. However, after being treated at 427° C. and 538° C., cracks, film fragments, and high-temperature corrosion products formed on coating surfaces even before their exposure to NSS. The crack and fragment formation exposed the underlying CRS substrate, resulting in severe corrosion after NSS exposure. In contrast, as shown in FIG. 2, the thermal treatment at 760° C. blackened HC00 samples, with much less surface rust observed even after NSS, compared to other thermally treated HC00 samples.

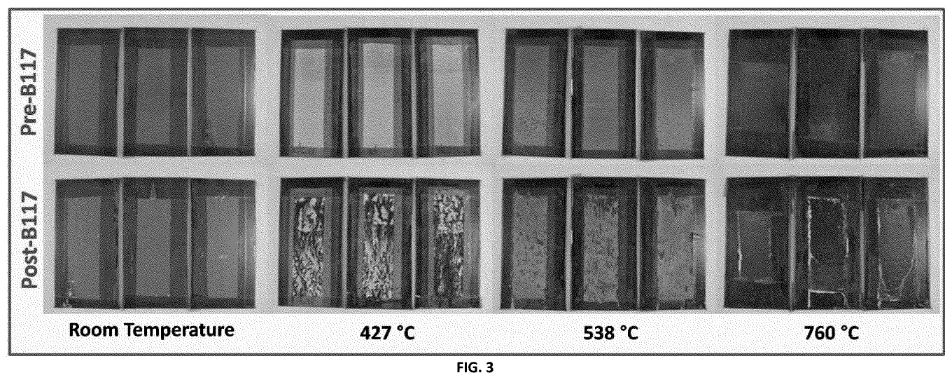

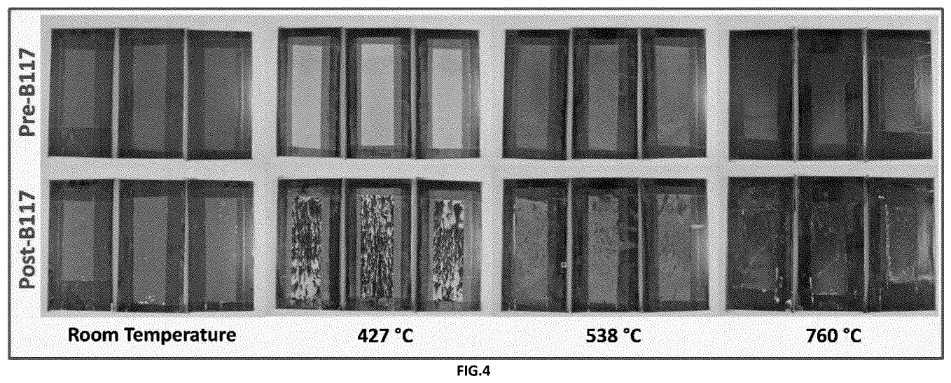

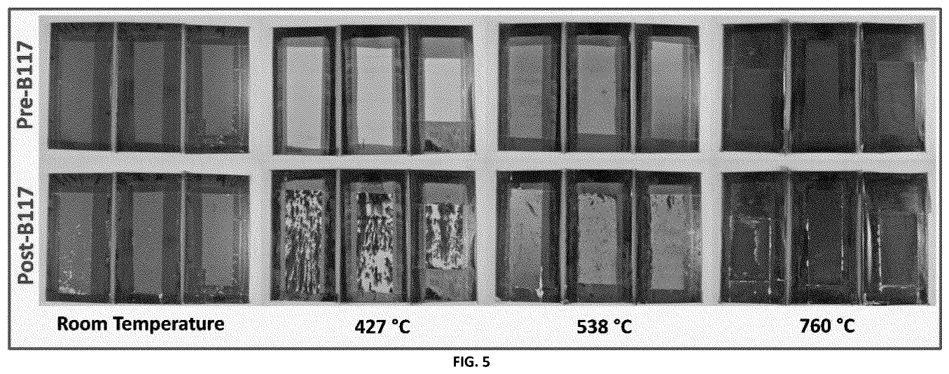

GF-Filled Coatings. FIG. 3 shows photos of HC35 coatings after being treated at different temperatures and 168 hours of neutral salt spray (NSS) following ASTM B117. Adding 35% frits (HC35) helped reduce rust before and after the NSS exposure. No visible rust was observed before NSS. After NSS, panels treated at 427° C. showed a fair amount of rust. However, at higher treatment temperatures of 538° C. and 760° C., surface rust was significantly less compared to control coatings (HC00). Especially at 760° C., only a small amount of rust was observed. FIG. 4 shows photos of HC45 coatings after being treated at different temperatures and 168 hours of neutral salt spray (NSS) following ASTM B117. Heat treatments had similar effects on coatings with 45% glass frits (HC45) to those with 35% glass frits (HC35). FIG. 5 shows photos of HC55 coatings after being treated at different temperatures and 168 hours of neutral salt spray (NSS) following ASTM B117. Panels coated with HC55 coatings (55% glass frits) appeared more corrosion-resistant, indicated by much less surface rust after NSS when the treatment temperatures are 538° C. and 760° C. FIG. 3, FIG. 4, and FIG. 5 show that adding GF fillers improved the corrosion performance of GF-filled coating samples: HC35, HC45, and HC55. These GF-filled coatings maintained intact films after heat treatments, showing only different degrees of discoloration before being exposed to NSS. Samples treated at 760° C. appeared blackened, similar to those of unfilled samples. As shown by FIG. 2 to FIG. 5, after NSS exposure, surface corrosion of the panels coated with GF-filled coatings is less severe (FIG. 3, FIG. 4, and FIG. 5) than that of panels coated with unfilled coatings (FIG. 2). This difference is especially prominent for samples being treated at 538° C. and 760° C. Notably, as shown in FIG. 5, after being treated at 760° C., HC55 coatings showed only negligible surface corrosion products even after NSS.

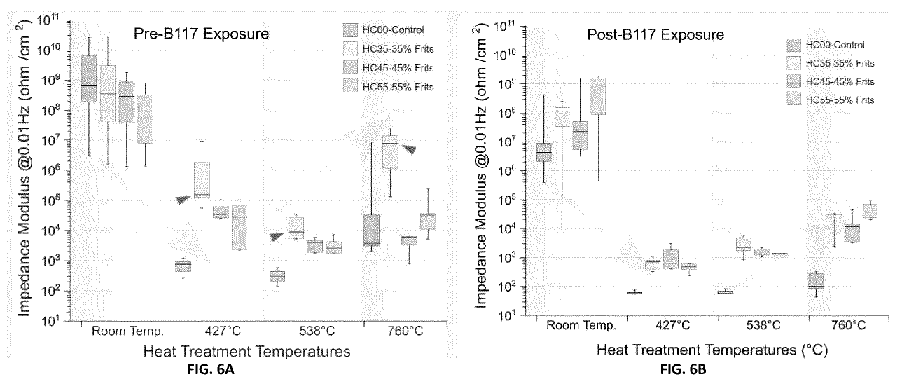

Coating Barrier Properties. FIG. 6A shows low-frequency (0.01 Hz) impedance moduli of coatings before NSS exposure following ASTM B117. FIG. 6B shows low-frequency (0.01 Hz) impedance moduli of coatings after NSS exposure following ASTM B117. Low-frequency impedance moduli were grouped by coatings' heat-treatment temperatures. Within each temperature group, coatings with different levels of GF fillers were shown. For each individual box plot, the center line is the median. Respectively, the top and bottom box edges are 75th and 25th percentile, and the upper and lower extremes of the whisker are the maximum and minimum values. Based on the low-frequency impedance moduli (an indicator of a coating's barrier performance), these coatings' barrier performance corresponded well with the corrosion performance before and after NSS (FIGS. 2, 3, 4, and 5), with a general trend that moderate treatment temperatures degraded coating, whereas the higher temperature converted a coating into a better barrier. As shown by FIG. 6, the heat-caused coating degradation clearly manifested in the downward trend of the coatings' low-frequency impedance modulus values when thermally treated at an increasing temperature: from room temperature up to 538° C. However, this trend is contradicted by increased modulus values from 538° C. to 760° C., particularly for coating HC35. Its impedance modulus remarkably increases from around 10 kOhm·cm² to 10 MOhm·cm². Before any heat treatments or NSS exposure, with increasing GF filler percentage, the coating's low-frequency impedance moduli decreased first (HC00 to HC35), stabilized (HC35 to HC45), and then decreased again (HC45 to HC55).

### 3.2 Mechanical and Thermal Properties of the Converted SiOC Coating

Coating modulus and hardness. Table 4 shows the results of the standard pencil hardness test, which is a commonly used method for assessing the hardness and scratch resistance of thin coatings.

TABLE 4
The pencil gouge and scratch hardness of HC00, HC35, HC45,
and HC55 coatings treated at 427° C., 538° C., and 760° C.
Pencil Hardness

| | Gouge | | | | Scratch | | | |
|---|---|---|---|---|---|---|---|---|
| Sample | RT | 427° C. | 538° C. | 760° C. | RT | 427° C. | 538° C. | 760° C. |
| HC00 | 6B | 6B | >8B | 7B | 7B | 6B | >8B | 7B |
| HC35 | 5H | >6H | >6H | >6H | 2B | >6H | >6H | >6H |
| HC45 | 6H | >6H | >6H | >6H | 2B | 6H | >6H | >6H |
| HC55 | >6H | >6H | >6H | >6H | H | >6H | >6H | >6H |

These results indicated that heat treatments at higher temperatures make unfilled coatings (HC00) slightly softer. In contrast, GF-filled coatings have high gauge hardness values, and increased scratch hardness values after being thermally treated, all reaching the max test limit, 6H.

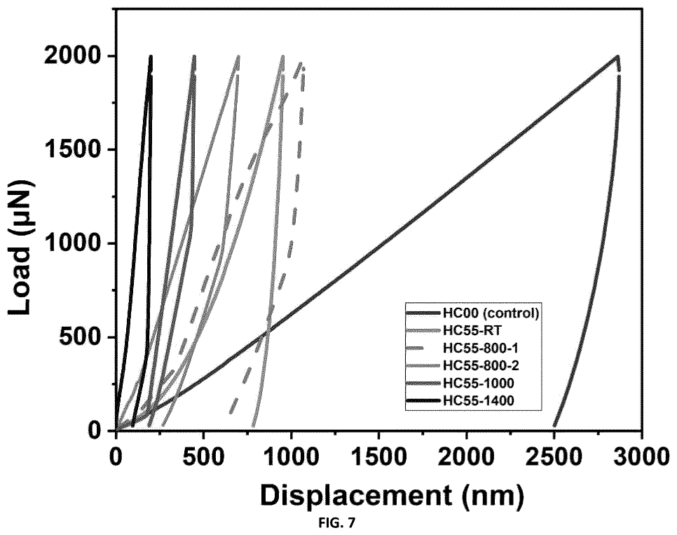

Nanoindentation. FIG. 7 shows nanoindentation load-displacement curves. As the heat treatment increased, samples HC00-RT, HC55-RT, HC55-800, HC55-1000, and HC55-1400 transition from plastic to elastic behavior. As shown by FIG. 7, without any heat treatment, the control coating sample (HC00-RT) showed plastic behavior with its loading curve widely separated from its unloading curve, which is almost vertical to the displacement axis. Sample HC55, under the same condition, displayed an elastoplastic behavior, with its plastic behavior diminishing by increasing treatment temperature. FIG. 7 showed after being treated at 538° C. and 760° C., HC55 behaved elastic. Table 5 confirms this trend, which shows the increasing value of reduced modulus and hardness with treatment temperature.

TABLE 5
The reduced modulus and hardness values from nanoindentation
tests of HC00 (control) and HC55 coatings treated at room
temperature (RT), 427° C., 538° C., and 760° C.

| | Reduced | | Maximum |
|---|---|---|---|
| Sample | Modulus | Hardness | Displacement |
| Name | (GPa) | (GPa) | (nm) |
| HC00-RT | 0.59 | 0.010 | 2869.50 |
| HC55-RT | 3.74 | 0.090 | 952.78 |
| HC55-800 | 1.55 | 0.036 | 1069.67 |
| HC55-1000 | 6.02 | 0.499 | 446.43 |
| HC55-1400 | 35.33 | 1.760 | 198.54 |

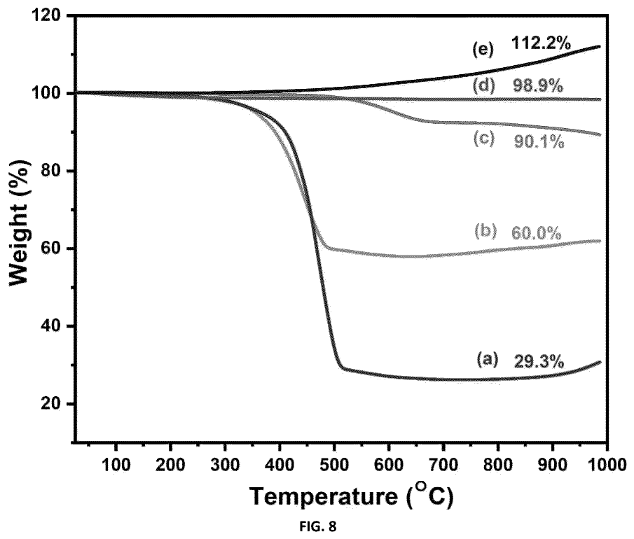

Thermal analysis. FIG. 8 shows thermogravimetric analysis (TGA) of the control coating (HC00-RT) and coatings with 35% glass frits (HC-35): a) HC00-RT, b) HC35-RT, c) HC35-800, d) HC35-1000, and e) HC35-1400. HC00 (control) coating samples showed two weight loss rates, a slow stage between 300° C. and 400° C. and an extremely fast stage between 400° C. and a little over 500° C. These two stages are also observed with HC35-RT samples, but with much less final weight loss (40.0% compared to 70.7% of HC00-RT, FIG. 8). For HC35-RT, both stages are much slower, and the total weight loss is only 9.9%. In contrast, as shown by FIG. 8, HC35-1000 barely loses any weight (1.1%), and HC35-1400 even gains 12.2% weight.

Slow release of polycondensation by-products accounted for the first weight loss stage. The restructuring reactions with the evolution of small molecules, mostly gaseous hydrocarbons, accounted for the second weight loss stage. Whereas weight loss, often a result of the decomposition and evolution of small molecules, indicated the stability of coatings under heat, and residual weight percentage had been used as the yield of polymer-ceramic conversion as the residual portion of the PDC is mainly the converted portion in practical uses. The increasing thermal treatment temperature is inversely proportional to the ceramic yield, as shown in FIG. 8. This behavior is attributed to the fact that, at higher treatment temperatures, a greater degree of conversion occurs prior to the TGA measurements. In this context, the TGA curves of HC00-RT and HC35-RT represent the baseline polymer-ceramic conversion for unfilled and GF-filled coatings. As shown by FIG. 8, the unfilled HC00-RT demonstrated a yield of around 29%, while HC35-RT showed a yield of about 60%. The 31% lower yield in HC35-RT is attributed to the presence of passive GF fillers (35% in this case). If the GF fillers were completely passive, one would expect HC35-RT's yield to be around 64% (29% from the unfilled coating plus 35% from the GF fillers) rather than the observed 60%. This discrepancy implies that the GF passive filler might play an active role in the conversion process.

In the absence of any heat treatment, HC35-RT is used as the baseline for evaluating the conversion yield of GF-filled coatings. To achieve a 90% yield, HC35-800 underwent a 30% weight loss when treated at 427° C. and an additional 10% during the TGA test due to incomplete precursor reactions, resulting in a conversion of 75%. When treated at 538° C., the conversion is nearly 100%, with minimal additional weight loss, likely attributed to enhanced crosslinking and rigidity. For samples HC00-RT, HC35-RT, and HC35-1400, puzzling weight gains were observed at a high temperature range of TGA, as the chamber was purged with nitrogen. The samples with weight gain coincided with those with free carbon in the coating matrix (confirmed by XRD).

### 3.3 Chemical Structural Evolution and Iron Oxidation During the PSX-SiOC Coating Conversion

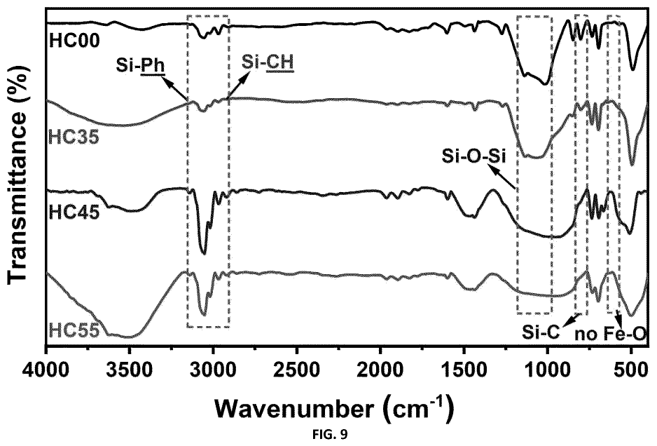

Si bonding at 427° C. FIG. 9 shows FTIR spectra of coatings HC00, HC35, HC45, and HC55 treated at 427° C. The spectra show the characteristic Si—C, Si—O—Si, and O—H vibrations. The presence of GF fillers influenced the fingerprint region. The absence of Fe—O, and Fe—OH peaks suggested minimal rust diffusion from the steel substrate. As shown in FIG. 9, all coating samples treated at 427° C. showed characteristic broad peaks in the range of 790 cm⁻¹, 1050-1100 cm⁻¹, 3450-3550 cm⁻¹, and 3550-3680 cm⁻¹, which likely corresponded to the Si—C, Si—O—Si, and O—H stretching vibrations of the moisture or residual solvent (1-butanol), and Si(OH)₂ network, respectively. Sharp peaks at around 2980-3090 cm⁻¹ indicated the presence of residual Si-attached —CH3 or —Ph groups, with their C—H bonds surviving the thermal treatment process. A broad peak at around 1160 cm⁻¹ corresponded to the Si—O—C open-link and cage-link structures. The observed Si—O—C structure arose from the loss of small molecules, which is thought to contribute to the porous matrix of the SiOC coating. These observations indicated that all coating samples, whether they have GF fillers or not, after being treated at 427° C., may not be fully crosslinked or transformed into SiOC ceramic. Moreover, the IR spectra of coatings without fillers differ significantly from those containing fillers, particularly in the fingerprint region. This is evident in broadened bands observed between 600 and 1500 cm⁻¹, which are likely attributed to the presence of glass frit fillers. No distinct peaks representing iron oxide (Fe—O) and hydroxide (Fe—OH) were detected in the range of 580-640 cm⁻¹ or at 1630 cm⁻¹. This absence suggests that minimal to no rust or iron oxide diffused into coating films treated at 427° C. Two factors contributed to the lack of rust in the coating film: a lower rate of iron oxidation and slow diffusion of reactants at 427° C. since the source of the rust is from the steel substrate.

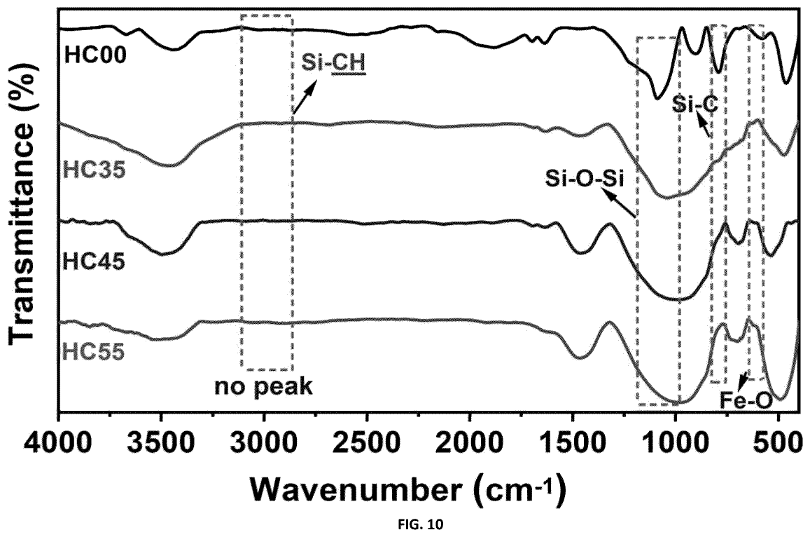

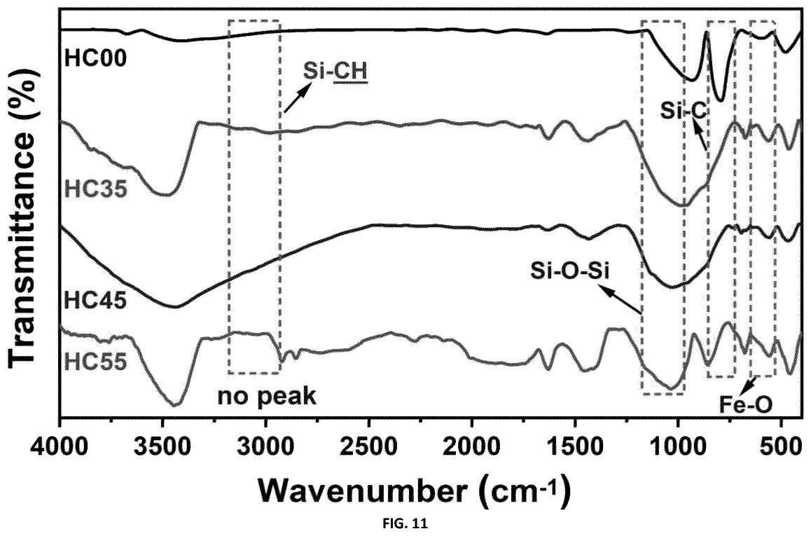

Si bonding above 538° C. FIG. 10 shows FTIR spectra of coatings HC00, HC35, HC45, and HC55 treated at 538° C. The disappearance of Si—CH₃/Si-Ph peaks indicated complete bond cleavage. Fe—O absorption at 580-640 cm⁻¹ suggested rust formation/iron oxidation starts at this temperature. FIG. 11 shows FTIR spectra of coatings HC00, HC35, HC45, and HC55 treated at 760° C. The intensified Fe—O peak at 630 cm⁻¹ and Fe—OH peak at 1625 cm⁻¹ confirmed faster rust formation/iron oxidation rate and diffusion at higher temperatures. As shown in FIGS. 10 and 11, coating samples treated at 538° C. and 760° C. display distinctive broad peaks at or in the range of 795 cm⁻¹, 1060-1100 cm⁻¹, 3430-3550 cm⁻¹, and 3550-3680 cm⁻¹, which could be attributed respectively to Si—C, Si—O—Si and O—H stretching vibrations of moisture or residual solvent (1-butanol), and Si(OH)₂ network stretching vibrations. The absence of characteristic C—H bonding peaks for Si—CH₃/Si-Ph groups around 2980-3090 cm 1 indicated the complete cleavage of Si—C bonds between the Si—CH₃/Si-Ph groups during the thermal treatment. Similar to the aforementioned results, broadened peaks were observed in the fingerprint region (600-1500 cm⁻¹) for coatings containing fillers. In FIG. 10 and FIG. 11, absorption peaks observed at 580-640 cm⁻¹ are attributed to iron oxide (Fe—O) formation, which intensifies with rising temperature, showing a sharp peak at 630 cm⁻¹ in FIG. 11 for the coating treated at 760° C. Another peak found at around 1625 cm⁻¹ is identified as the stretching vibration of the iron hydroxyl group in γ(Fe—OH).

The effective peaks of both Fe—O and Fe—OH confirmed the growth of rust/iron oxide at high temperatures (538° C. & 760° C.). The overall FT-IR analysis confirmed the effect of temperature on the formation of SiOC coatings, rust growth at the steel/coating interface, and rust diffusion into the coating matrix. These results agreed with the magnetic properties and XPS studies in the following sections.

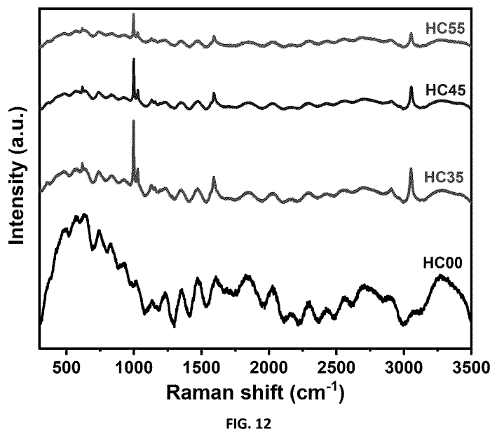

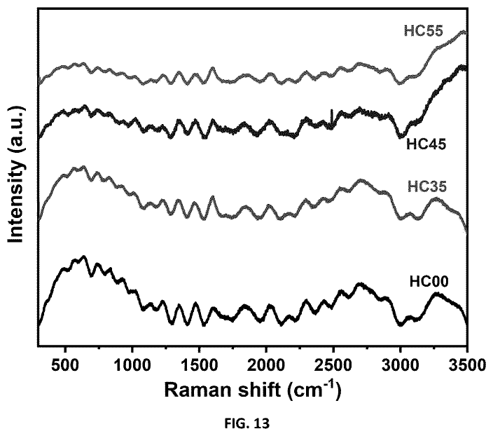

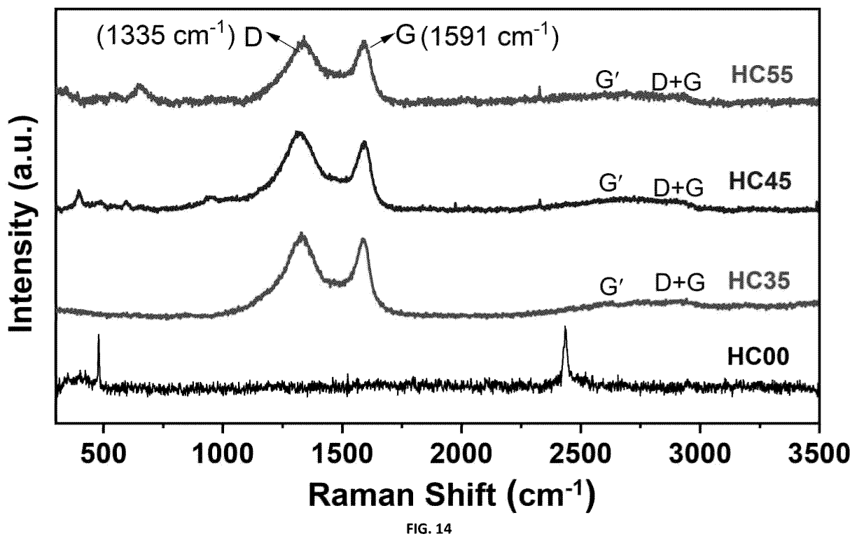

Carbon content. FIG. 12 shows Raman spectra of samples HC00, HC35, HC45, and HC55 after being treated at 427° C. FIG. 13 shows Raman spectra of samples HC00, HC35, HC45, and HC55 after being treated at 538° C. FIG. 14 shows Raman spectra of coatings HC00, HC35, HC45, and HC55 treated at 760° C. The distinct D (˜1335 cm⁻¹) and G (˜1591 cm⁻¹) bands are indicative of free carbon formation at higher thermal treatment temperature (760° C.). No substantial Raman signals were detected from the coating samples treated at 427° C. and 538° C. As shown in FIG. 12 and FIG. 13, these coatings contain little to no free carbon under these treatment conditions. Conversely, as shown in FIG. 14, coatings treated at 760° C. exhibited two significant peaks at ˜1335 cm⁻¹ and ˜1591 cm⁻¹, characteristic for the D and G bands of free carbon in SiOC ceramic coatings.

The D band denotes the defect, or disordered sp³ hybridized carbon from the out-plane vibration of free graphitic carbon, whereas the G band represents the vibration of the sp² hybridized carbon from the in-plane vibration of the C—C bond. Moreover, the broad G′ or 2D band (a secondary overtone of an in-plane mode) at 2625 cm⁻¹ and a weak Raman shift at 2910 cm⁻¹ are attributed to the combination of D+G band vibration mode.

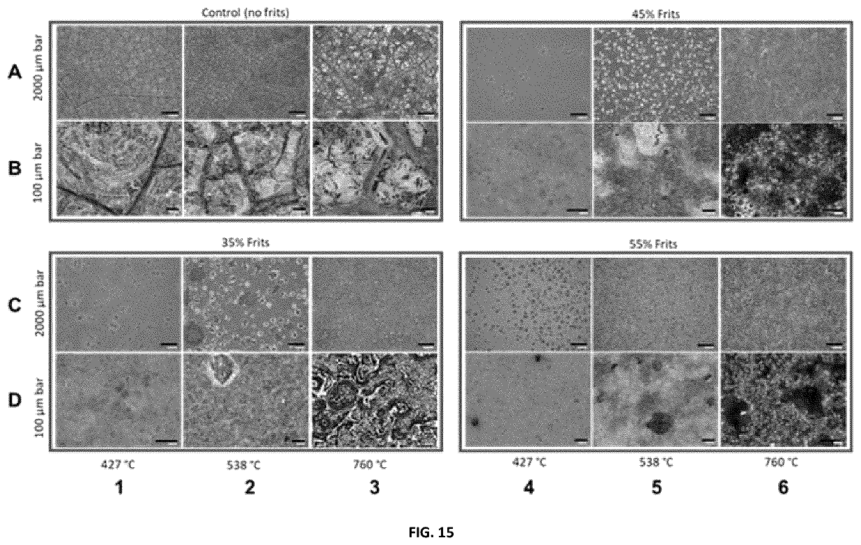

FIG. 15 shows optical microscope images of coating samples treated at different temperatures. Images of two scales shown are: 1) rows A and C have a scale bar of 2000 μm size; and 2) rows B and D have a scale bar of 100 μm size. Each column corresponds to a treatment temperature. The images illustrate the crack formation of the control coating (HC00, in the top left panel) and sample color changes according to the thermal treatment temperatures. Crack-free coating films were observed in all the samples with glass frits. The different shades of coating color indicated different iron oxidation rates at different treatment temperatures. As shown by FIG. 15, control samples treated at 760° C. showed no free carbon, likely due to the evolution of COₓ gases as the result of the rapid oxidation of free carbon with ambient oxygen available through a fragmented sample surface. In contrast, free carbon was detected in coating samples treated with the same temperature, but having GF at different percentages (35%, 45%, and 55% by weight), attributed to the spreading of melted/softened GF fillers acting as a barrier to ambient oxygen.

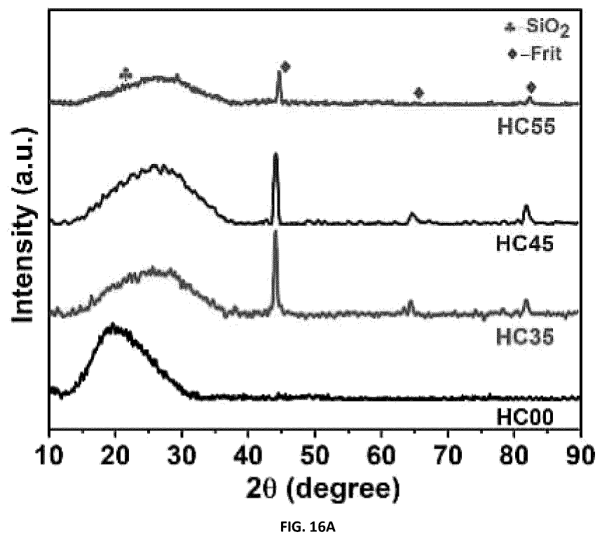

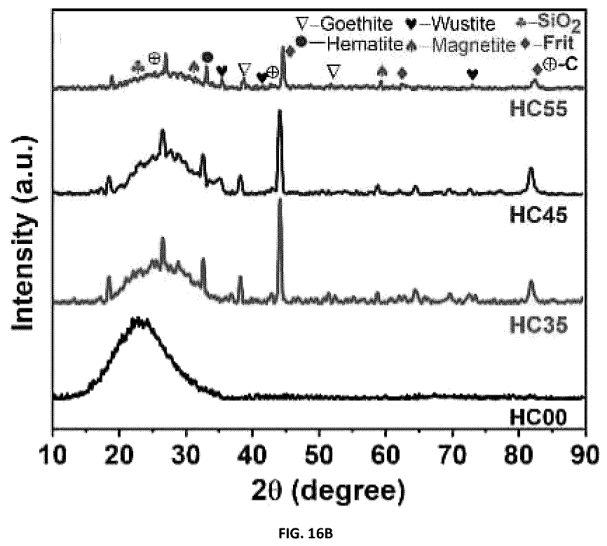

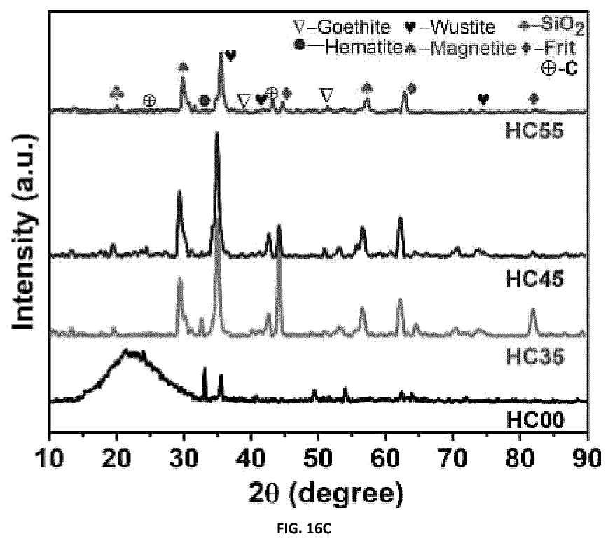

Crystalline structures (XRD). FIG. 16A shows XRD patterns of coating samples HC00, HC35, HC45, and HC55 thermally treated at 427° C. FIG. 16B shows XRD patterns of coating samples HC00, HC35, HC45, and HC55 thermally treated at 538° C. FIG. 16C shows XRD patterns of coating samples HC00, HC35, HC45, and HC55 thermally treated at 760° C. The pattern change showed the transition of coating films from an amorphous to a semi-crystalline SiOC network. Peaks of free carbon, α-alumina, and iron oxides/oxyhydroxides confirmed phase evolution with increasing treatment temperature. For FIG. 16A and FIG. 16B, the broad peaks observed at 22° of samples treated at 427° C. and 538° C. are characteristic of SiO₂ tetrahedral, which is from the amorphous region of the SiOC matrix. Conversely, the sharp peak at 22.5° of samples treated at 760° C. is an indicator of the semi-crystalline region in the SiOC matrix, as well as phase separation in the matrix.

For FIG. 16B and FIG. 16C, the small peaks observed at 26.1° and 43.3° with samples treated at 538° C. and 760° C. indicated the presence of free carbon (graphite). The weak peak at around 26° and the strong peak at 43.5° are signs of turbostratic carbon structure between graphitic and amorphous state. The distinctive peaks observed at 45° and 62.6° correspond to alumina phases, which is contained in the GF mixture. These values suggested that the alumina present in the mixture is primarily α-alumina. The broad peaks of GF-containing samples shown in FIG. 16A to FIG. 16C suggested that the frit mixture is amorphous.

The presence of iron oxide and oxyhydroxide is confirmed by 2-theta values at around 35°, 41°, and 72° for wustite (FeO), 31° and 62° for magnetite (Fe₃O₄), 36° and 52° for goethite (FeOOH), 33° for hematite (Fe₂O₃), as shown in FIG. 16B and FIG. 16C.

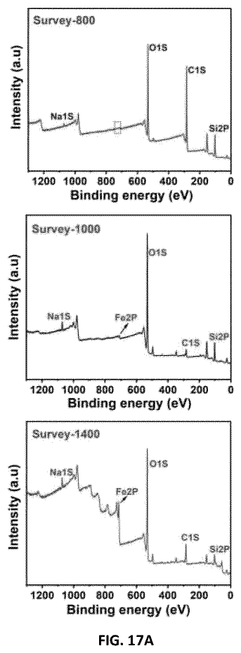

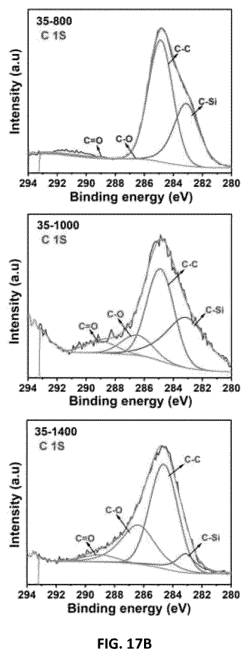

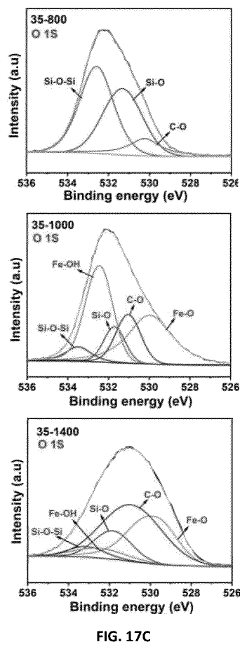

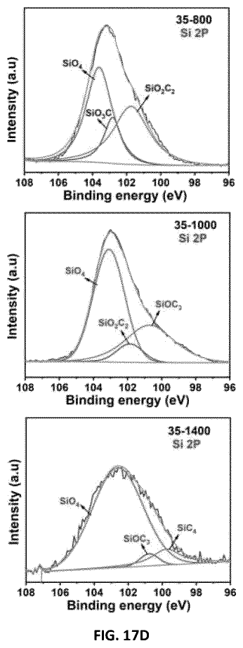

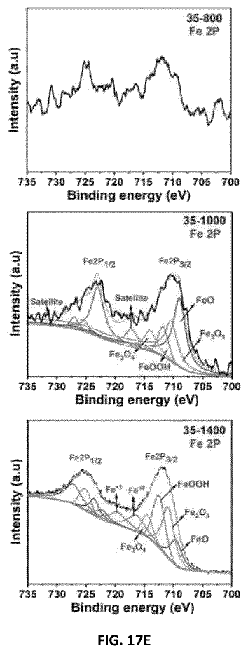

X-ray photoelectron spectroscopy (XPS), FIG. 17A to FIG. 17E shows XPS spectra of sample HC35 at different thermal treatment temperatures, wherein FIG. 17A corresponds to survey spectra, FIG. 17B corresponds to C 1s, FIG. 17C corresponds to O 1s, FIG. 17D corresponds to Si 2p, and FIG. 17E corresponds to Fe 2p deconvoluted spectra. FIG. 17A shows XPS spectra of sample HC35 at different thermal treatment temperatures (top spectra corresponds to 800° C., middle spectra corresponds to 1000° C., and bottom spectra corresponds to 1400° C.), wherein the spectra correspond to survey spectra. FIG. 17B shows XPS spectra of sample HC35 at different thermal treatment temperatures (top spectra corresponds to 800° C., middle spectra corresponds to 1000° C., and bottom spectra corresponds to 1400° C.), wherein the spectra correspond to C 1s deconvoluted spectra. FIG. 17C shows spectra of sample HC35 at different thermal treatment temperatures (top spectra corresponds to 800° C., middle spectra corresponds to 1000° C., and bottom spectra corresponds to 1400° C.), wherein the spectra correspond to O 1s deconvoluted spectra. FIG. 17D shows spectra of sample HC35 at different thermal treatment temperatures (top spectra corresponds to 800° C., middle spectra corresponds to 1000° C., and bottom spectra corresponds to 1400° C.), wherein the spectra correspond to Si 2p deconvoluted spectra. FIG. 17E shows spectra of sample HC35 at different thermal treatment temperatures (top spectra corresponds to 800° C., middle spectra corresponds to 1000° C., and bottom spectra corresponds to 1400° C.), wherein the spectra correspond to Fe 2p deconvoluted spectra. The spectral analysis confirmed SiOC network evolution, carbon bonding variations, and the formation of iron oxides/oxyhydroxides at higher temperatures. The presence of C, O, and Si atoms in all samples was confirmed by the survey spectra of samples HC35-800, HC35-1000, and HC35-1400, while Fe was only detected in samples HC35-1000 and HC35-1400, as shown by Table 6 and FIG. 17A.

TABLE 6
XPS fitting parameters for C1s, Si2p, O1s, and Fe2p of the hybrid coating HC35
treated at 427° C. (HC35-800), 538° C. (HC35-1000), and 760° C. (HC35-1400).

| | Element | | | | | | | |
|---|---|---|---|---|---|---|---|---|
| | C 1S | | Si 2P | | O 1S | | Fe 2P_{3/2} | |
| Coating Sample | State | B.E. (eV) | State | B.E. (eV) | State | B.E. (eV) | State | B.E. (eV) |
| HC35-800 | C—Si | 283.14 | SiO₂C₂ | 101.74 | C—O | 530.24 | — | — |
| | C—C | 284.88 | SiO₃C | 102.81 | Si—O | 531.35 | — | — |
| | C—O | 286.57 | SiO₄ | 103.62 | Si—O—Si | 532.63 | — | — |
| | C═O | 289.08 | — | — | — | — | — | — |
| HC35-1000 | C—Si | 283.23 | SiOC₃ | 100.73 | C—O | 530.89 | FeO | 709.10 |
| | C—C | 284.94 | SiO₂C₂ | 101.86 | Si—O | 531.72 | Fe₂O₃ | 710.50 |
| | C—O | 286.60 | SiO₄ | 103.12 | Si—O—Si | 533.42 | FeOOH | 711.94 |
| | C═O | 289.09 | — | — | Fe—O | 529.94 | Fe₃O₄ | 714.05 |
| | — | — | — | — | Fe—OH | 532.47 | | |
| HC35-1400 | C—Si | 283.16 | SiC₄ | 99.83 | C—O | 530.91 | FeO | 709.62 |
| | C—C | 284.65 | SiOC₃ | 100.79 | Si—O | 531.86 | Fe₂O₃ | 710.98 |
| | C—O | 286.43 | SiO₄ | 102.73 | Si—O—Si | 533.18 | FeOOH | 712.59 |
| | C═O | 289.12 | — | — | Fe—O | 529.89 | Fe₃O₄ | 714.48 |
| | — | — | — | — | Fe—OH | 532.58 | | |

Deconvolution of C 1s spectra in FIG. 17B showed four peaks at 283.2, 284.6, 286.5, and 290.0 eV, which are designated to C—Si, C—C, C—O, and C═O, respectively. The C—Si and C—C peaks likely arose from carbon bonding with surface Si, while C—O peaks came from oxygen-bonded carbon (e.g., CO and CO₂) adsorbed on the SiOC surface.

The deconvoluted O₁s spectra of sample HC35-800 in FIG. 17C showed C—O, Si—O, and Si—O—Si bonds at around 530.3, 531.4, and 533.0 eV, respectively. Fe—O and Fe—OH are confirmed in samples HC35-1000 and HC35-1400 by peaks at 530.9, 531.7, 533.4, 529.9, and 532.4 eV, originating from various iron oxides (FeₓO_{y}) and iron oxyhydroxides (Fe(OH)ₓ).

Deconvoluted Si 2p spectra of HC35-800 in FIG. 17D showed peaks around 101.7, 102.8, and 103.6 eV, confirming the presence of SiO₂C₂, SiO₃C, and SiO₄. In contrast, the spectra of HC35-1000 showed a SiOC₃ peak at 100.7 eV, along with SiO₂C₂ and SiO₄ peaks. In sample HC35-1400, two additional distinct carbon-rich structures, SiC₄ and SiOC₃, are identified at 99.8, 100.8, and 102.7 eV, indicating a higher carbon ratio.

The deconvoluted Fe2p_{3/2} spectra of samples HC35-1000 and HC35-1400 in FIG. 17E showed strong peaks at around 709.5, 710.6, 712.2, and 714.1 eV, respectively, indicating the presence of FeO (wustite), Fe₂O₃ (hematite), FeOOH (goethite), and Fe₃O₄ (magnetite). In addition, the presence of Fe³⁺ is confirmed in sample HC35-1000 via the satellite peak at 718.0 eV, which disappeared in sample HC35-1400. This change is due to the conversion of Fe²⁺ to Fe³⁺ as a result of the transition of Fe₂O₃ and FeOOH into Fe₃O₄ at 760° C.

### 3.4 Iron Oxidation and its Kinetics

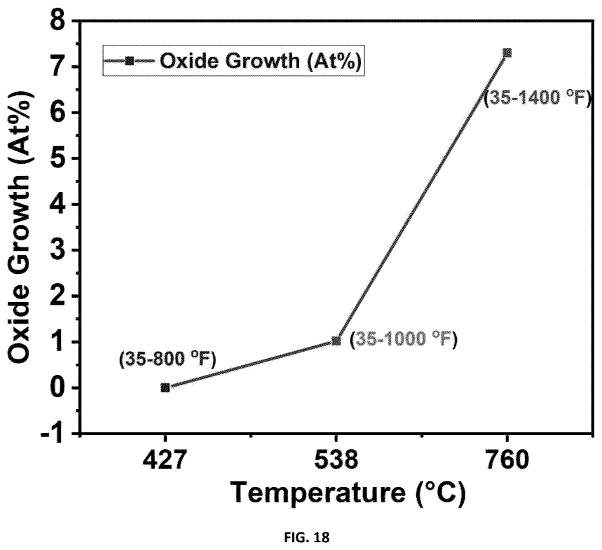

FIG. 18 shows oxidation kinetics of HC35 at elevated temperatures. Oxide growth kinetics was obtained by fitting atomic percentage data from XPS spectra at thermal treatment temperatures 427° C., 538° C., and 760° C. Multiple pieces of evidence confirmed the incorporation of iron oxides/oxyhydroxides into the coating matrix starting at above 538° C., the first being IR adsorption peaks at 580-640 cm⁻¹ from FeO and 1625 cm 1 from γ(Fe—OH) shown in FIG. 10 and FIG. 11. Second, XRD 2-theta values at around 35°, 41°, and 72° for FeO, 31° and 62° for Fe₃O₄, 36° and 52° for goethite FeOOH, 33° for Fe₂O₃, shown in FIG. 16B and FIG. 16C. Third, atomic % from the deconvoluted XPS Fe2p peaks fits well with the parabolic oxidation law as shown in FIG. 18. The data used for fitting are provided in Table 7.

TABLE 7
Fe atomic percentages obtained from XPS analysis for
the different samples, which are used to examine
the applicability of the Parabolic Oxidation Law.

| Sample | Fe atomic % |
|---|---|
| 35-800 | 0 |
| 35-1000 | 1.02 |
| 35-1400 | 7.3 |

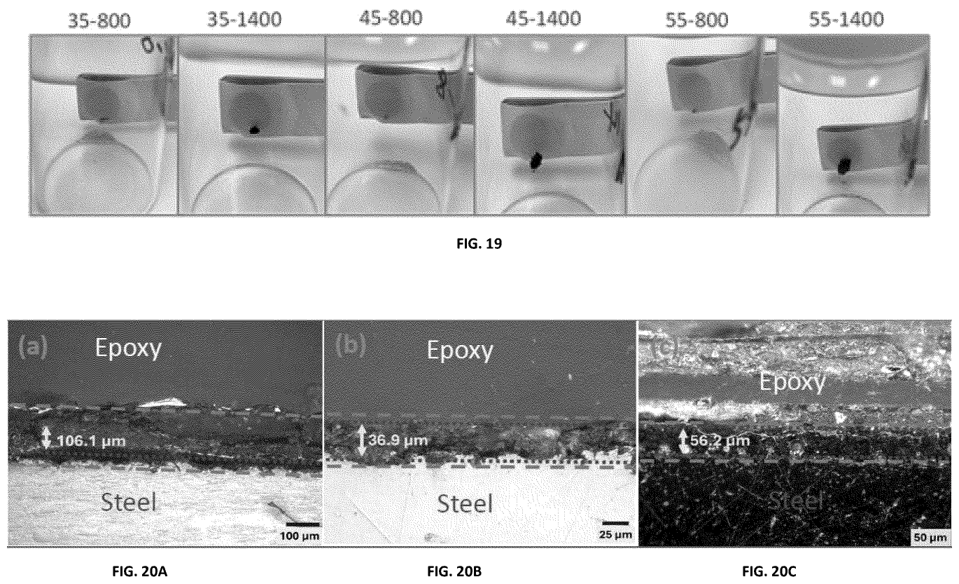

FIG. 19 shows magnetic property of samples being treated at higher temperatures. Samples from left to right correspond to the following samples: HC35-800, HC35-1400, HC45-800, HC45-1400, HC55-800, and HC55-1400. Samples with iron oxidation products moved up the side of the glass vials with the magnetic bar. The magnetism tests, shown in FIG. 19, also proved that the iron oxides/oxyhydroxides are incorporated into the SiOC coating matrix when samples are treated at above 538° C.

The activation energy of the oxide growth reaction in the hybrid film is determined as shown below:

$$log \frac{{k}_{2}^{′}}{{k}_{1}^{′}} = \frac{Δ {E}_{a}}{2.303 R} ( \frac{1}{{T}_{1}} - \frac{1}{{T}_{2}} ) \qquad ( 1 )$$

wherein k′ is the oxidation rate based on weight, ΔEₐ is the activation energy, T is the temperature, and R is the gas constant 8.314 J·K⁻¹·mol⁻¹. The oxidation rate k′ here is based on the weight (approximated due to the nature of oxide being a mixture), instead of being based on the oxide film thickness, which is impractical to measure in this work. The conversion is based on the following calculations.

$$\frac{dy}{dt} = \frac{k}{y}$$

wherein t is the time, k is the oxidation rate, and y is the oxide film thickness, which was converted to weight increase using equation (2):

$$w = \frac{ρ \cdot V}{A} = ρ \cdot y \qquad ( 2 )$$

$$\frac{dw}{dt} = \frac{{k}^{′}}{w} , where {k}^{′} = {ρ}^{2} \cdot k$$

wherein A is area, ρ is density, V is oxide volume, w is oxide weight per unit area, t is time, k is the oxidation rate in terms of film thickness (m/s), and k′ is the oxidation rate based on weight. V/A convert oxide volume to its thickness per unit area. With equations 1 and 2, the activation energy can be obtained as 124 KJ/mol, which is higher than iron oxidation at lower temperatures. This high activation energy was due to the good barrier coating formed at higher temperatures, which also justifies the use of the parabolic oxide growth law that is more suitable to describe the oxide growth with its total high-temperature corrosion current flow comprising both ionic and electronic flow, namely the Wagner Mechanism. Ionic flow includes both iron cations and oxygen anions, whereas electronic flow is the hopping of electrons in the semiconductive SiOC/oxide matrix.

### 3.5 Film Characteristics and Elemental Mapping by SEM

Film appearance. At higher temperatures (e.g., 427° C.), as shown in FIG. 15, the polysiloxane coating film underwent thermal treatment and formed compact glass-like structures. Without glass frit filler, cracks developed starting around 10 μm wide at 427° C., expanding to 50-100 μm wide at 538° C., and eventually over 100 μm wide at 760° C. With rising temperatures, the appearance of the glassy film transitioned from a transparent amber color to a more saturated reddish color, and eventually to a gray translucent appearance. The gray appearance may be due to the smaller cracks developed within the larger fragments, which is evident at the higher temperature, i.e., 760° C. The reddish color, coming from the oxide content in the inorganic SiOC film, intensifies with the rising temperature that accelerates ion diffusion and thus iron oxidation, which is confirmed with a spectroscopic analysis of the film's chemical structure evolution and the magnetic characteristic.

FIG. 20A shows a cross-section image from a digital optical microscope corresponding to HC00-RT. FIG. 20B shows a cross-section image from a digital optical microscope corresponding to HC35-1400. FIG. 20C shows a cross-section image from a digital optical microscope corresponding to HC55-1400. Gaps at the coating-substrate interface were observed from the control coating (HC00), whereas tightly bound interfaces were observed from thermally-treated (760° C.) coatings filled with glass frits (HC35-1400 and HC55-1400). As shown in FIG. 20A to 20C, a small gap at the coating-substrate interface was observed for the control panel coating (HC00), whereas intact interfaces were observed from GF-filled coatings treated at higher temperatures, i.e., HC35-1400 and HC55-1400, which are also free of pores or cracks. As shown in FIG. 20A, the HC00-RT has a film thickness of 106 μm, HC35-1400 37 μm, and HC55-1400 56 μm.

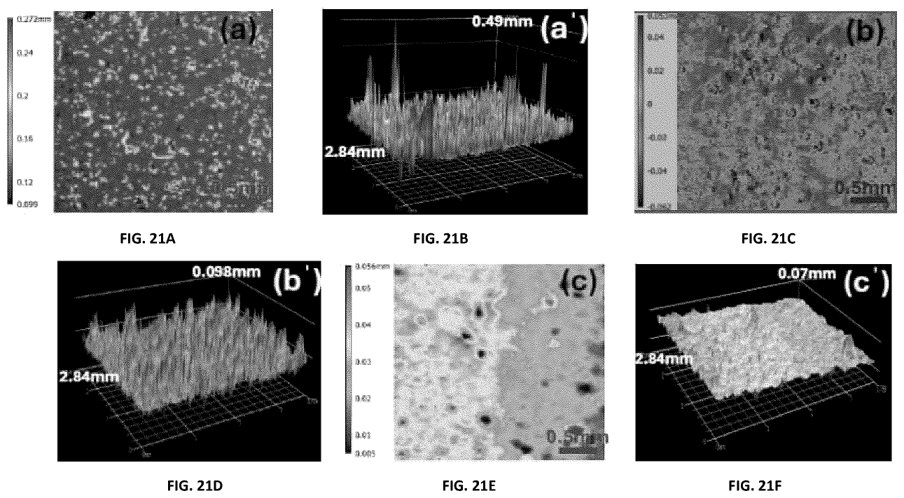

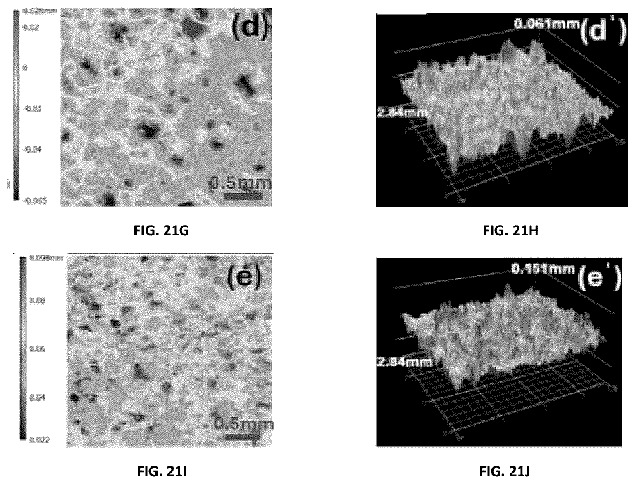

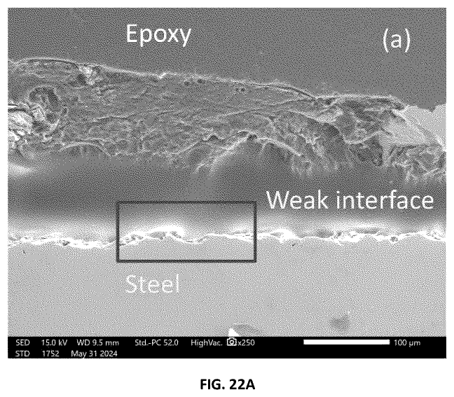

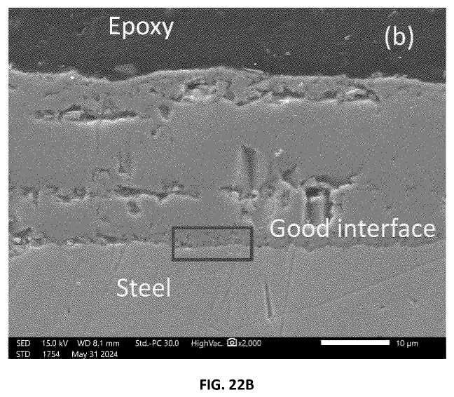

Surface roughness. FIG. 21A shows sample HC00-RT surface roughness characterized by an optical profilometer in 2D. FIG. 21B shows sample HC00-RT surface roughness characterized by an optical profilometer in 3D. FIG. 21C shows sample HC55-RT surface roughness characterized by an optical profilometer in 2D. FIG. 21D shows sample HC55-RT surface roughness characterized by an optical profilometer in 3D. FIG. 21E shows sample HC55-800 surface roughness characterized by an optical profilometer in 2D. FIG. 21F shows sample HC55-800 surface roughness characterized by an optical profilometer in 3D. FIG. 21G shows sample HC55-1000 surface roughness characterized by an optical profilometer in 2D. FIG. 21H shows sample HC55-1000 surface roughness characterized by an optical profilometer in 3D. FIG. 21I shows sample HC55-1400 surface roughness characterized by an optical profilometer in 2D. FIG. 21J shows sample HC55-RT surface roughness characterized by an optical profilometer in 3D. In general, heat treatment made the coating surface smoother, attributed to glass fillers' melting/softening effects. Before any heat treatment, unfilled coating samples have the highest roughness values, with HC00-RT having an average roughness (Ra) of 13.64 μm and the GF-filled HC55-RT 13.76 μm. However, the roughness of HC00-RT was highly affected by scattered high-peak regions, whereas, as shown by FIGS. 21A and 21B, the rougher regions of HC55-RT appeared uniform. Heat treatment at 800° F. made HC55 smoother with a Ra of 3.80. Conversely, as shown by FIG. 21G to 21J, increasing treatment temperature further made the coating surface slightly rougher: HC55-1000 has a Ra of 9.90 μm, and HC55-1400 has a Ra of 9.52 μm. In general, heat treatments made the coatings' surface smoother.

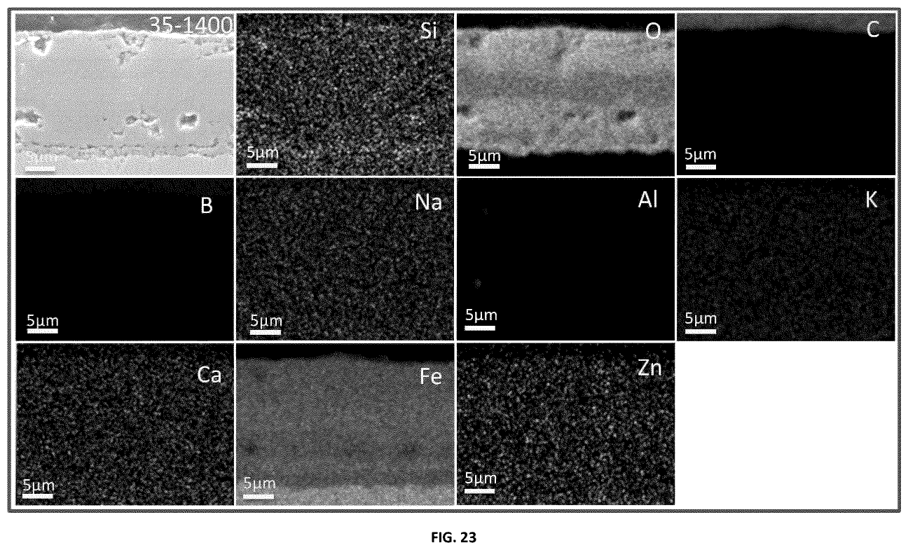

SEM elemental mapping. FIG. 22A and FIG. 22B shows coating cross-section morphology from SEM backscattering images. Samples shown are a) HC00-RT (FIG. 22A) and b) HC35-1400 (FIG. 22B). The coating sample with glass frits (HC35-1400) shows significantly improved coating-substrate binding, compared to control coating (HC00-RT) without glass frits. FIG. 23 shows cross-section elemental mapping of a thermally treated coating sample with glass frits. The elemental mapping was done through an SEM/EDS analysis on sample HC35-1400. The presence of multiple active metals was from the dispersed inert glass frits, which are oxide mixtures. The SiOC conversion is supported by the presence of Si and O. Weak coating-substrate bonding, like those observed with an optical microscope, is shown FIG. 22A with the cross-section SEM image of the control sample (HC00-RT). In contrast, HC35-1400 in FIG. 22B showed an intact and well-adhered interface. As shown in FIG. 23, the elemental mapping of the HC35-1400 cross-section showed the Si and O from the SiOC phase (carbon concentration below EDS detection limit), and Na, Al, K, Ca, and Zn from the GF fillers. Fe element is also observed throughout the coating film. The uniform distribution of K, Na, and Zn in coating HC35-1400 was attributed to their diffusion during the thermal treatment. The lack of a boron signal is because it is a low-energy X-ray element (an atom number smaller than 11); in addition to that, chemical bonding could cause its characteristic X-ray peak shift.

### 4. Discussion

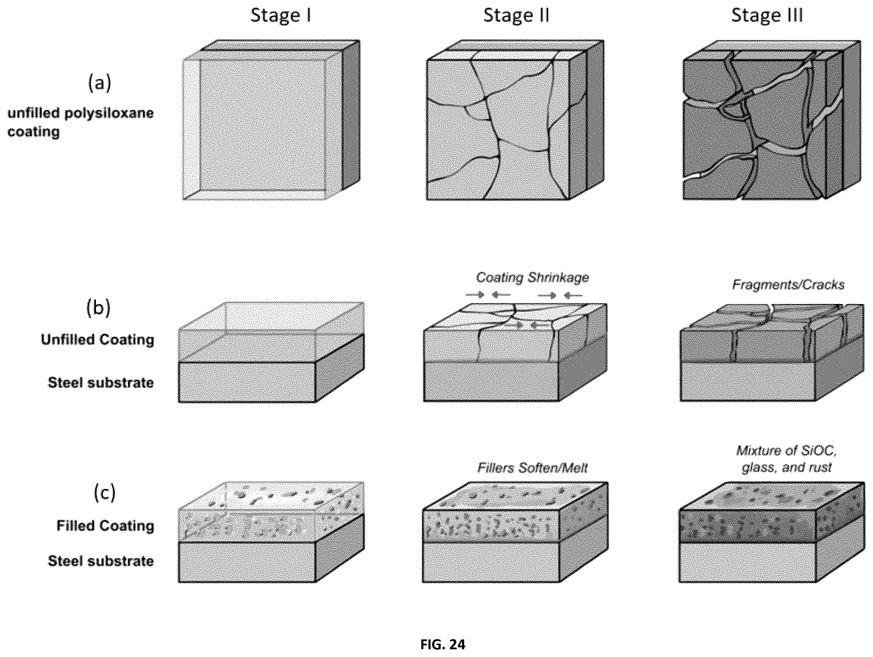

FIG. 24 shows schematics of the crack-free hybrid coating formation mechanism. The columns in the schematics are the stages of coating degradation or conversion at increasing temperatures. The first (a) and second (b) rows show two sets of perspective views of an unfilled coating (control) on a steel substrate with increasing shrinkage and consequent cracks at different stages. The third row (c) illustrates the views of a filled hybrid coating on a steel substrate, with lighter dots representing dispersed glass frits, which, at the last two stages, melt/soften and spread throughout the coating, and the darker dots representing rust, which grows out of the substrate-coating interface and eventually intermixed with the rest of the coating matrix, compensating the crack-causing coating shrinkage. Good barrier property is one of the most important criteria for the corrosion performance of a protective coating. Ideally, the SiOC coating studied here should maintain good barrier properties throughout different stages of its conversion process (FIG. 24):
Stage I: siloxane coating before any thermal treatment
Stage II: siloxane coating (SiOC conversion starts) treated at a moderate-high temperature
Stage III: Fully converted form of SiOC coating

At Stage I, increasing the amount of GFs as fillers would improve or maintain the siloxane coating's barrier performance to the point around its critical pigment volume concentration (CPVC). Based on coating low-frequency moduli before any thermal treatments or NSS, though without exact CPVC measurements, it is understood that the siloxane coating reaches its CPVC between 45% and 55% loading by weight, indicated by stabilized modulus values between 35% and 45% before the drop between 45% and 55%, as shown in FIGS. 6A and 6B.

At the same time, the GF fillers soften or melt starting at Stage II, acting as a plasticizer or passive filler in terms of SiOC ceramic glass. Eventually, at Stage III, the GF fillers are homogeneously incorporated into the final SiOC matrix. The good barrier property for coating films at Stages II and III depends on minimizing the crack formation during the conversion process, which benefits from the higher load of the GF fillers. Therefore, formulating the initial siloxane coating around its CPVC with GF fillers would provide a balanced good barrier performance for coating films at all stages.

Thermal treatment at a higher temperature usually results in faster and more severe degradation and compromised barrier property of organic coatings. However, for the example coatings herein there is a clear upward trend of low-frequency impedance moduli from samples treated at 538° C. to those at 760° C., as shown by FIGS. 6A and 6B. This trend, together with the less observed surface rust and degradation from NSS, clearly indicated a better barrier film formed from the conversion process at higher temperatures. This is attributed to the formation of crack-free SiOC films, assisted by the GF fillers and iron oxide/oxyhydroxide (rust).

Arguments might arise that this upward trend is also observed in control samples (HC00) without any GF fillers, as shown in FIG. 24. However, the low-frequency impedance moduli of the control samples are extremely low. The increasing moduli is attributed to uncontrolled surface oxide growth, as previously observed in Wiering et al., Prog. Org. Coat. 2021, 159, 106418. This phenomenon is also reviewed by Chen et. al., Oxid. Met. 2003, 59 (5), 433-468 summarizing oxide (scale) structures formed in the air at different temperatures: 1) below 700° C. (1292° F.) features irregular bi-layer structures, and 2) above 700° C. three-layer structures of hematite (top)/magnetite/wustite (bottom). Chen's observation of scale formation on carbon steel open to the air implies that various oxide structures with drastically different barrier properties can form under the temperature-controlled oxide growth kinetics.

During heat treatments, the polysiloxane precursor coating gradually converted to a SiOC coating, undergoing a series of chemical and physical changes. At a relatively lower temperature, i.e., 427° C., the conversion to SiOC was only partial indicated by FTIR absorptions of organic groups such as C—H, Si—O—Si, Si—C, and O—H, as shown in FIG. 9. Iron oxidation at the temperature was moderate with slight color change of the coating films, but lacked spectroscopic evidence of iron oxides. The lower mechanical strength of films treated at 427° C. is attributed to their amorphous structure and incomplete conversion to SiOC.

At higher temperatures, i.e., 538° C. and 760° C., FTIR absorption peaks of organic groups disappear, as shown by FIG. 10 and FIG. 11. Coating films treated at these temperatures not only had a complete conversion to SiOC but also contained an appreciable amount of iron oxides/oxyhydroxides, evidenced by a simple magnetism test shown in FIG. 19, in addition to characteristic FTIR absorptions of FIG. 10 and FIG. 11, XPS deconvoluted spectra of FIG. 17A to FIG. 17E, and the oxide growth kinetics of FIG. 18. The fact that the iron oxidation kinetics followed the parabolic oxidation law with a high activation energy, as shown in FIG. 18, indicated that a good barrier film was formed. In addition, a high-modulus SiOC matrix, plasticizing effects of GF fillers, as shown in FIG. 7, and reinforcing effects of free carbons, as shown in FIG. 14, accounted for the good mechanical properties of the final converted film. Furthermore, the free carbons can form a mixed bonding network, reinforcing the coating matrix, thus improving the coating film's mechanical strength and thermal stability. Raman spectroscopy of FIG. 14 and XRD results of FIG. 16A to FIG. 16C confirmed the presence of free carbon within the SiOC matrix at elevated temperatures, which affects the samples' weight changes, as shown in TGA results in FIG. 8. Notably, the weight gain starting at 600° C. for the HC35-1400 coating treated at 760° C. can be attributed to the formation of stable oxides and carbon nitride compounds, as indicated by the TGA results obtained under a nitrogen atmosphere, which is presented by curve e) in FIG. 8. This phenomenon is typically observed when free carbon reacts with nitrogen at elevated temperatures. As a result, the reaction can cause the mass to increase due to the incorporation of nitrogen atoms into the SiOC ceramic network. Additionally, the impurities in nitrogen gas can also potentially react with free carbon in the carbon-containing samples. As a result, the slight mass increase observed for HC00-RT and HC35-RT between 900° C. and 1000° C. is likely due to the adsorption or chemisorption of reactive gases, such as oxygen or nitrogen, from the surrounding environment, leading to the formation of stable oxides or nitride compounds. As shown in FIG. 8, thermal stability improves with increasing treatment temperature from room temperature (RT) to 1400° C., which indicated the formation of robust, glass-like SiOC ceramic structures at higher temperatures.

FIG. 24 illustrates three clearly defined stages of the siloxane-SiOC conversion and coating film formation, with each component in the formula playing different roles. The siloxane resin functions as a coating binder and film-former initially, then a SiOC precursor in the later stage when subjected to thermal treatment. GF filers function as passive fillers for SiOC film, reducing the internal stress of the film and preventing crack development. Iron oxidation products, though often indicating metal degradation, function as active fillers for the SiOC film, further preventing crack development and improving the film integrity under heat stress.

GF fillers are critical to forming crack-free SiOC coating film in Stages II and III. Without GF fillers (HC00 samples) and as supported by FIG. 2 to FIG. 6B, and FIG. 15, cracks develop readily into fragments falling off the substrates, resulting in poor barrier properties and severe corrosion. These cracks formed primarily due to the evolution of small gaseous molecules from breaking C—H bonds and creating new Si—O and Si—C bonds. While the difference in the coefficient of thermal expansion (CTE) between the substrate and coating plays a role, it usually does not cause wide cracks observed. In Stage II, relatively slowly, gaseous hydrocarbons (CH₄, C₆H₆, etc.) start evolving from the matrix, causing unavoidable volume shrinkage and substantial mass loss (up to ˜30% by weight as supported by FIG. 8), at the same time, raising the internal stress in the intermediate SiOC system. At this stage, the partially converted SiOC film still acts as a barrier limiting ion transportation, evidenced by the minimal iron oxide detected (from film appearance, as shown in FIG. 15, and spectroscopic analyses, as shown in FIG. 9 to FIG. 11, FIGS. 16A-16C, and FIGS. 17A-17E).

In Stage III, the evolution of gaseous small molecules continues at a higher rate, causing further shrinkage and building up internal stress, eventually leading to wider cracks with exposed substrate. As supported by FIG. 2 to FIG. 5, and FIG. 15, the wide cracks provide more access to ambient oxygen, which, at high temperatures, induces faster rust growth, fragmentation of the SiOC film, and final detachment of the fragmented film.

In contrast, adding low-melting-point GF fillers eliminated the cracks due to the internal stress reduction by softened/melted filler particles. This effect is further confirmed by the elastoplastic transition detected by nanoindentation tests in these GF-filled films, as shown in FIG. 7. The transition had three contributing factors: 1) the conversion of the soft polysiloxane network to hard glassy SiOC ceramic, 2) the passive GF fillers, which are much harder than the precursor polymer matrix, and 3) the iron oxides/oxyhydroxides that diffuse into the coating matrix (evidenced from FTIR, XRD, and XPS results, as shown in FIG. 9 to FIG. 11, FIGS. 16A-16C, and FIGS. 17A-17E).

Note that at the onset of the elastoplastic transition (Stage II at 427° C., a relatively lower treatment temperature), glass fillers soften/melt but remain localized, resulting in a large degree of matrix nonuniformity, which contributed to thermal stress reduction by distributing low-modulus “soft” domains, as shown in FIG. 7. Existing of these “soft” domains coincided with the non-uniform loading-displacement curve observed from HC55-800 samples in FIG. 7. These localized “soft” domains and their stress reduction contributed to the development of crack-free matrix at higher treatment temperatures in Stage III.

At higher treatment temperatures (Stage III), GF fillers' stress-reduction plasticizing effect is insufficient to compensate for the severe shrinkage due to faster small molecule evolution and substantial weight loss (up to about 70% as shown in FIG. 8). Instead, at this stage, coatings' barrier property and corrosion performance significantly benefited from the iron oxidation, which, though inapparent, happened across the whole coating film, not just at the coating-substrate interface. This is critical because the inward diffusion of oxygen and outward diffusion of iron resulted in the entrapped iron oxidation products, as shown in FIG. 9 to FIG. 11, FIGS. 16A-16C, FIGS. 17A-17E, and FIG. 19, and compensated for the volume loss of the final film, as shown in FIG. 8 to FIG. 11, FIGS. 16A-16C, FIGS. 17A-17E, and FIG. 19, which otherwise is the root cause of severe film cracking.

As shown in FIG. 15, the incorporation of iron oxidation products is evident from the changes in the film appearance, the magnetic nature of the film, and spectroscopic analyses. Furthermore, the thicker coating film with a higher load of GF filler and rising temperature contributed to the formation of iron oxide/oxyhydroxide layers and dense frit glass films (a mixture of iron oxidation products and melted frit).

The Examples demonstrated a new approach to making SiOC ceramic coatings through a 3-stage process: starting from a glass frit (GF) filled polysiloxane (Stage I, room temperature), followed by an initial thermal treatment at moderately elevated temperatures (Stage II, 427° C.), and a final thermal treatment at very high temperature (Stage III, 538-760° C.). The final glassy ceramic coatings maintained structural integrity and corrosion resistance even after being subjected to temperatures up to 760° C.

At Stage I, the GF fillers functioned as common organic coating fillers, showing better barrier performance when the coatings' PVC is lower than their CPVC. At Stage II, the GF fillers functioned as a plasticizer, softening or melting to reduce the internal stress of the film, preventing cracks common to SiOC ceramic coatings. At Stage III, in addition to the plasticizing effect of GF fillers, the iron oxides/oxyhydroxides formation across the coating films compensated for the severe film shrinkage that usually causes further cracking.

The 3-stage process was evident from the appearance change (as shown in FIG. 15), chemical structure evolution (as shown in FIG. 9 to FIG. 14, FIGS. 16A-16C, and FIGS. 17A-17E), low-frequency impedance moduli, and corrosion performance. The plasticizing role of GF is confirmed by the local elastoplastic transition of the coating films shown in nanoindentation tests (FIG. 7). The role of iron oxides/oxyhydroxides and their presence is confirmed by the better film integrity at higher temperatures and spectroscopic evidence from FTIR, XPS, XRD, and a simple magnetic test, as shown in FIG. 9 to FIG. 11, FIGS. 16A-16C, FIGS. 17A-17E, and FIG. 19.

The claimed invention is:

1. A method for preparing a corrosive-resistant product, comprising:
coating a metal substrate with a pre-ceramic polymer composition comprising at least one silicone resin, at least one glass frit dispersed in the silicone resin, and optionally at least one solvent, wherein the metal substrate is at least partially coated; and
subjecting the coated metal substrate to thermal treatment to diffuse metal oxides from the metal substrate into a coating matrix and induce crosslinking and pyrolysis of the at least one silicone resin to prepare a metal-oxide-impregnated polymer-derived ceramic.

2. The method of claim 1, wherein the metal substrate comprises iron or steel, and wherein the metal oxides comprise iron oxides, iron hydroxides, and/or iron oxyhydroxides.

3. The method of claim 1, wherein the at least one silicone resin comprises a polysiloxane resin, a polycarbosiloxane resin, a polycarbosilane resin, a polycarbodiimide resin, a polysilazane resin, a polyborosilazane resin, a polyborosilane resin, a polyborosiloxane resin, or a combination comprising two or more thereof.

4. The method of claim 1, wherein the at least one silicone resin comprises a polysiloxane resin.

5. The method of claim 1, wherein the at least one silicone resin comprises poly(methylphenylsiloxane).

6. The method of claim 1, wherein the at least one silicone resin has a viscosity of 3000 mPas at 25° C.

7. The method of claim 1, wherein based on the total weight of the pre-ceramic polymer composition, the at least one silicone resin is present in an amount of 30 wt. % to 95 wt. %.

8. The method of claim 1, wherein the at least one glass frit has a melting point below 450° C.

9. The method of claim 1, wherein the at least one glass frit comprises Li₂O, B₂O₃, Na₂O, Al₂O₃, SiO₂, K₂O, CaO, ZnO, Bi₂O₃, V₂O₅, F, TiO₂, or a combination comprising two or more thereof.

10. The method of claim 1, wherein based on the total weight of solid components of the pre-ceramic polymer composition, the at least one glass frit is present at a percent by weight of 1 wt. % to 65 wt. %.

11. The method of claim 1, wherein based on the total weight of the pre-ceramic polymer composition, the at least one glass frit is present at a percent by weight of 0.5 wt. % to 60 wt. %.

12. The method of claim 1, wherein the at least one solvent comprises 1-butanol, xylene, n-propanol, isobutanol, isopropanol, n-pentanol, 2-methyl butanol, sec-butyl alcohol, isobutyl alcohol, butyl CELLOSOLVE solvent (ethylene glycol n-butyl ether), isopropyl acetate, butyl acetate, methyl ethyl ketone, methyl isobutyl ketone, xylene, UCAR n propyl propionate, UCAR n-pentyl propionate, toluene, VM & P™ Naphtha, Aromatic 100, parachlorobenzotrifluoride (PCBTF), Mineral Spirits 66/3, or a combination thereof.

13. The method of claim 1, wherein based on the total weight of the pre-ceramic polymer composition, the at least one solvent is present at a percent by weight of 0 wt. % to 20 wt. %.

14. The method of claim 1, wherein the thermal treatment of the coated metal substrate is conducted at a temperature range of 200° C. to 1400° C.

15. The method of claim 1, wherein the thermal treatment is open-to-air.

16. The method of claim 1, wherein the metal-oxide-impregnated polymer-derived ceramic is a SiCₓO₂₍₁₋ₓ₎+yC_{free} ceramic, wherein x is selected from the range of 0 to 1, C_{free} is the amount of free carbon present in the coating matrix, and y is selected from the range 0 to 1.

17. The method of claim 1, wherein the metal-oxide-impregnated polymer-derived ceramic is a silicon oxycarbide (SiOC) glassy ceramic.

18. The method of claim 1, wherein the metal-oxide-impregnated into the polymer-derived ceramic comprises FeO, Fe₂O₃, Fe₃O₄, FeOOH, or a combination comprising two or more thereof.

19. A coated substrate, comprising:
a metal substrate; and
a metal-oxide-impregnated polymer-derived ceramic coating comprising the metal oxide, metal hydroxides, and/or metal oxyhydroxide from the metal substrate, and at least one glass frit.

20. An article of manufacture comprising an object, wherein at least a portion of at least one surface of the object is the coated substrate of claim 19.
